(19) United States
(12) Patent Application Publication
(10) Pub. No.: US 2013/0096886 A1
(43) Pub. Date: Apr. 18, 2013

(54) System and Method for Extracting Features from Data Having Spatial Coordinates

(71) Applicants: Borys Vorobyov, Gloucester (CA); Yuriy Monastyrev, Kharkiv (UA); Andrey Zaretskiy, Kharkiv (UA); Dmytro Gordon, Kharkiv (UA); Oleksandr Monastyrev, Kharkiv (UA)

(72) Inventors: Borys Vorobyov, Gloucester (CA); Yuriy Monastyrev, Kharkiv (UA); Andrey Zaretskiy, Kharkiv (UA); Dmytro Gordon, Kharkiv (UA); Oleksandr Monastyrev, Kharkiv (UA)

(21) Appl. No.: 13/638,912

(22) PCT Filed: Mar. 31, 2011
(86) PCT No.: PCT/CA2011/000353

§ 371 Date: Nov. 29, 2012

Related U.S. Application Data
(60) Provisional application No. 61/319,785, filed on Mar. 31, 2010.

(51) Int. Cl. G06F 17/50

(52) U.S. Cl. CPC G06F 17/5004
USPC 703/1

(57) ABSTRACT

Systems and methods are provided for extracting various features from data having spatial coordinates. The systems and methods may identify and extract data points from a point cloud, where the data points are considered to be part of the ground surface, a building, or a wire (e.g. power lines). Systems and methods are also provided for extracting wires from a noisy environment, for separating buildings from attached vegetation, for reconstructing a building, and for classifying data points according to their relief and terrain characteristics. The extraction of the features may be carried out automatically by a computing device.

### CROSS-REFERENCE TO RELATED APPLICATIONS

This application claims priority from U.S. Provisional Application No. 61/319,785 filed on Mar. 31, 2010, which is incorporated herein by reference in its entirety.

### TECHNICAL FIELD

The following relates generally to extracting features from data points with spatial coordinates.

### DESCRIPTION OF THE RELATED ART

In order to investigate an object or structure, it is known to interrogate the object or structure and collect data resulting from the interrogation. The nature of the interrogation will depend on the characteristics of the object or structure. The interrogation will typically be a scan by a beam of energy propagated under controlled conditions. The results of the scan are stored as a collection of data points, and the position of the data points in an arbitrary frame of reference is encoded as a set of spatial-coordinates. In this way, the relative positioning of the data points can be determined and the required information extracted from them.

Data having spatial coordinates may include data collected by electromagnetic sensors of remote sensing devices, which may be of either the active or the passive types. Non-limiting examples include LiDAR (Light Detection and Ranging), RADAR, SAR (Synthetic-aperture RADAR), IFSAR (Interferometric Synthetic Aperture Radar) and Satellite Imagery. Other examples include various types of 3D scanners and may include sonar and ultrasound scanners.

LiDAR refers to a laser scanning process which is usually performed by a laser scanning device from the air, from a moving vehicle or from a stationary tripod. The process typically generates spatial data encoded with three dimensional spatial data coordinates having XYZ values and which together represent a virtual cloud of 3D point data in space or a “point cloud”. Each data element or 3D point may also include an attribute of intensity, which is a measure of the level of reflectance at that spatial data coordinate, and often includes attributes of RGB, which are the red, green and blue color values associated with that spatial data coordinate. Other attributes such as first and last return and waveform data may also be associated with each spatial data coordinate. These attributes are useful both when extracting information from the point cloud data and for visualizing the point cloud data. It can be appreciated that data from other types of sensing devices may also have similar or other attributes.

The visualization of point cloud data can reveal to the human eye a great deal of information about the various objects which have been scanned. Information can also be manually extracted from the point cloud data and represented in other forms such as 3D vector points, lines and polygons, or as 3D wire frames, shells and surfaces. These forms of data can then be input into many existing systems and workflows for use in many different industries including for example, engineering, architecture, construction and surveying.

A common approach for extracting these types of information from 3D point cloud data involves subjective manual pointing at points representing a particular feature within the point cloud data either in a virtual 3D view or on 2D plans, cross sections and profiles. The collection of selected points is then used as a representation of an object. Some semi-automated software and CAD tools exist to streamline the manual process including snapping to improve pointing accuracy and spline fitting of curves and surfaces. Such a process is tedious and time consuming. Accordingly, methods and systems that better semi-automate and automate the extraction of these geometric features from the point cloud data are highly desirable.

Automation of the process is, however, difficult as it is necessary to recognize which data points form a certain type of object. For example, in an urban setting, some data points may represent a building, some data points may represent a tree, and some data points may represent the ground. These points coexist within the point cloud and their segregation is not trivial.

From the above it can be understood that efficient and automated methods and systems for identifying and extracting features from 3D spatial coordinate data are highly desirable.

### BRIEF DESCRIPTION OF THE DRAWINGS

Embodiments of the invention or inventions will now be described by way of example only with reference to the appended drawings wherein:

FIG. 1 is a schematic diagram to illustrate an example of an aircraft and a ground vehicle using sensors to collect data points of a landscape.

FIG. 2(a) is a block diagram of an example embodiment of a computing device and example software components.

FIG. 2(b) is an example set of data point representing spatial coordinates.

FIG. 3 is a flow diagram illustrating example computer executable instructions for extracting features from a point cloud.

FIG. 4 is a flow diagram illustrating example computer executable instructions for extracting a ground surface from a point cloud.

FIG. 5 is a flow diagram illustrating example computer executable instructions continued from FIG. 4.

FIG. 6 is a flow diagram illustrating example computer executable instructions continued from FIG. 5.

FIG. 7 is a schematic diagram illustrating an example ground surface and the example measurements of various parameters to extract the ground surface from a point cloud.

FIG. 8 is a flow diagram illustrating example computer executable instructions for extracting a building from a point cloud.

FIG. 9 is a top-down plane view of a visualization of an exemplary point cloud.

FIG. 10 is a top-down plane view of a building extracted from the exemplary point cloud in FIG. 9.

FIG. 11 is a perspective view of the building extracted from the example point cloud in FIG. 9.

FIG. 12 is a flow diagram illustrating example computer executable instructions for separating vegetation from buildings in a point cloud.

FIG. 13 is a flow diagram illustrating example computer executable instructions for reconstructing a building model from “building” points extracted from a point cloud.

FIG. 14 is a flow diagram illustrating example computer executable instructions continued from FIG. 13.

FIG. 15 is a perspective view of example “building points” extracted from a point cloud.

FIG. 16 is an example histogram of the distribution of points at various heights.

FIG. 17 is a schematic diagram illustrating an example stage in the method for reconstructing a building model, showing one or more identified layers having different heights.

FIG. 18 is a schematic diagram illustrating another example stage in the method for reconstructing a building model, showing the projection of the layers' boundary line to form walls.

FIG. 19 is a schematic diagram illustrating another example stage in the method for reconstructing a building model, showing the projected walls, ledges, and roofs of a building.

FIG. 20 is a perspective view of an example building reconstructed from the building points in FIG. 15.

FIG. 21 is a flow diagram illustrating example computer executable instructions for extracting wires from a point cloud.

FIG. 22 is a flow diagram illustrating example computer executable instructions continued from FIG. 21.

FIG. 23 is a flow diagram illustrating example computer executable instructions continued from FIG. 22.

FIG. 24 is a schematic diagram illustrating an example stage in the method for extracting wires, showing segments of a principal wire extracted from a point cloud.

FIG. 25 is a schematic diagram illustrating another example stage in the method for extracting wires, showing the projection of non-classified points onto a plane, whereby the plane is perpendicular to the principal wire.

FIG. 26 is a schematic diagram illustrating another example stage in the method for extracting wires, showing the projection of non-classified points onto a plane to identify wires.

FIG. 27 is a flow diagram illustrating example computer executable instructions for extracting wires in a noisy environment from a point cloud.

FIG. 28 is a flow diagram illustrating example computer executable instructions continued from FIG. 27.

FIGS. 29(a) through (e) are a series of schematic diagrams illustrating example stages in the method for extracting wires in a noisy environment, showing: a wire segment in FIG. 29(a); an origin point and Y-axis added to the wire segment in FIG. 29(b); an X-axis and a Z-axis added to the wire segment in FIG. 29(c); a first and a second polygon constructed around an end of the wire segment in FIG. 29(d); a proposed wire extension in FIG. 29(e); and, an extended wire segment including the proposed wire extension in FIG. 29(f).

FIG. 30 is a flow diagram illustrating example computer executable instructions for extracting relief and terrain features from a ground surface of a point cloud.

FIG. 31 is a flow diagram illustrating example computer executable instructions continued from FIG. 30.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The proposed systems and methods extract various features from data having spatial coordinates. Non-limiting examples of such features include the ground surface, buildings, building shapes, vegetation, and power lines. The extraction of the features may be carried out automatically by a computing device. The extracted features may be stored as objects for retrieval and analysis.

As discussed above, the data may be collected from various types of sensors. A non-limiting example of such a sensor is the LiDAR system built by Ambercore Software Inc. and available under the trade-mark TITAN.

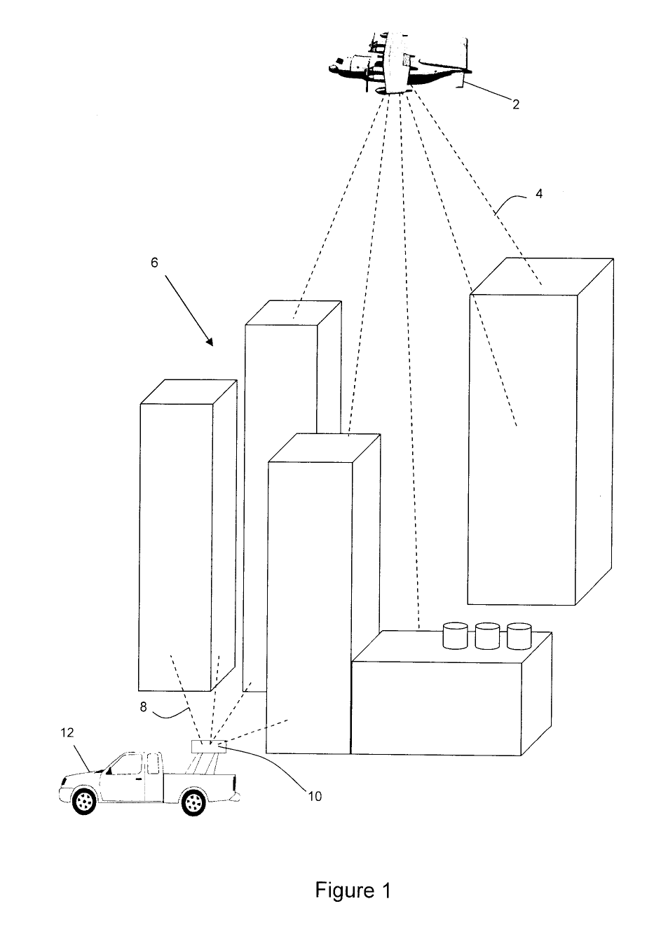

Turning to FIG. 1, data is collected using one or more sensors 10 mounted to an aircraft 2 or to a ground vehicle 12. The aircraft 2 may fly over a landscape 6 (e.g. an urban landscape, a suburban landscape, a rural or isolated landscape) while a sensor collects data points about the landscape 6. For example, if a LiDAR system is used, the LiDAR sensor 10 would emit lasers 4 and collect the laser reflection. Similar principles apply when an electromagnetic sensor 10 is mounted to a ground vehicle 12. For example, when the ground vehicle 12 drives through the landscape 6, a LiDAR system may emit lasers 8 to collect data. It can be readily understood that the collected data may be stored onto a memory device. Data points that have been collected from various sensors (e.g. airborne sensors, ground vehicle sensors, stationary sensors) can be merged together to form a point cloud.

Each of the collected data points is associated with respective spatial coordinates which may be in the form of three-dimensional spatial data coordinates, such as XYZ Cartesian coordinates (or alternatively a radius and two angles representing Polar coordinates). Each of the data points also has numeric attributes indicative of a particular characteristic, such as intensity values, RGB values, first and last return values and waveform data, which may be used as part of the filtering process. In one example embodiment, the RGB values may be measured from an imaging camera and matched to a data point sharing the same coordinates.

The determination of the coordinates for each point is performed using known algorithms to combine location data, e.g. GPS data, of the sensor with the sensor readings to obtain a location of each point with an arbitrary frame of reference.

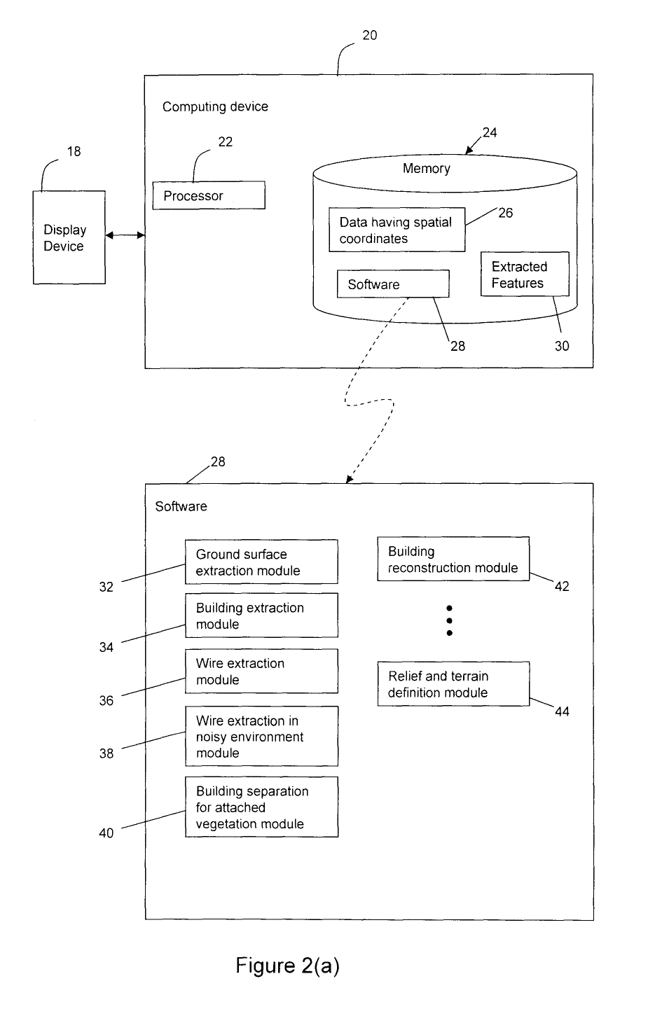

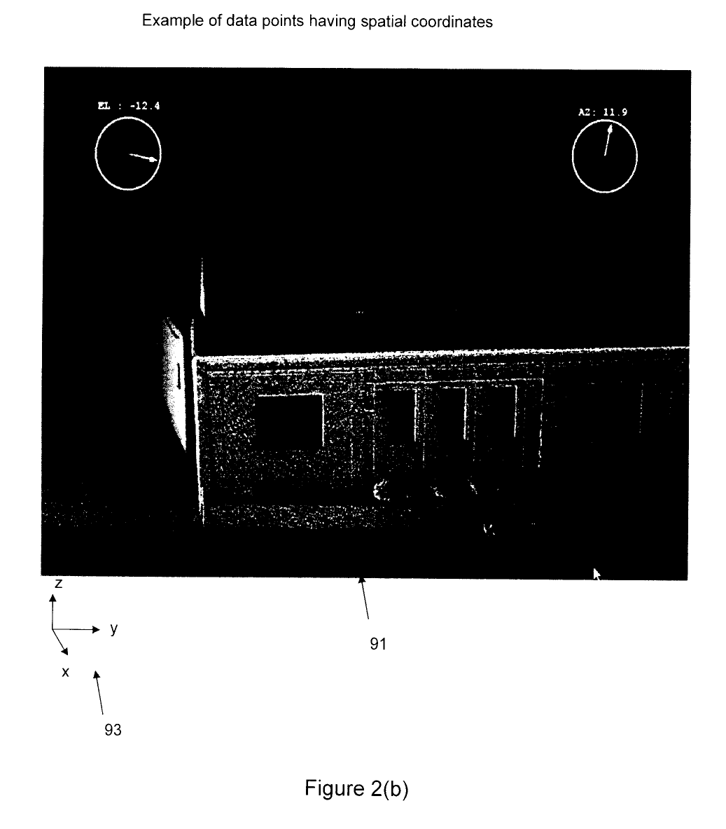

Turning to FIG. 2(a), a computing device 20 includes a processor 22 and memory 24. The memory 24 communicates with the processor 22 to process data. It can be appreciated that various types of computer configurations (e.g. networked servers, standalone computers, cloud computing, etc.) are applicable to the principles described herein. The data having spatial coordinates 26 and various software 28 reside in the memory 24. A display device 18 may also be in communication with the processor 22 to display 2D or 3D images based on the data having spatial coordinates 26.

It can be appreciated that the data 26 may be processed according to various computer executable operations or instructions stored in the software. In this way, the features may be extracted from the data 26.

Continuing with FIG. 2(a), the software 28 may include a number of different modules for extracting different features from the data 26. For example, a ground surface extraction module 32 may be used to identify and extract data points that are considered the “ground”. A building extraction module 34 may include computer executable instructions or operations for identifying and extracting data points that are considered to be part of a building. A wire extraction module 36 may include computer executable instructions or operations for identifying and extracting data points that are considered to be part of an elongate object (e.g. pipe, cable, rope, etc.), which is herein referred to as a wire. Another wire extraction module 38 adapted for a noisy environment 38 may include computer executable instructions or operations for identifying and extracting data points in a noisy environment that are considered to be part of a wire. The software 28 may also include a module 40 for separating buildings from attached vegetation. Another module 42 may include computer executable instructions or operations for reconstructing a building. There may also be a relief and terrain definition module 44. Some of the modules use point data of the buildings' roofs. For example, modules 34, 40 and 42 use data points of a building's roof and, thus, are likely to use data points that have been collected from overhead (e.g. an airborne sensor).

It can be appreciated that there may be many other different modules for extracting features from the data having spatial coordinates 26.

Continuing with FIG. 2(a), the features extracted from the software 28 may be stored as data objects in an “extracted features” database 30 for future retrieval and analysis. For example, features (e.g. buildings, vegetation, terrain classification, relief classification, power lines, etc.) that have been extracted from the data (e.g. point cloud) 26 are considered separate entities or data objects, which are stored the database 30. It can be appreciated that the extracted features or data objects may be searched or organized using various different approaches.

FIG. 2(b) shows an example of a point cloud 91 or set of data points representing spatial coordinates. As can be seen, there are many points, in this example, representing a building and vegetation. The set of data points are located in 3D space and can be defined by an x,y,z frame of reference 93. The x,y,z frame of reference 93, and more particularly the x and y axes, also defines a horizontal plane. In an example embodiment, the horizontal plane is aligned to be perpendicular to the gradient of the gravity field. However, the horizontal plane and the frame of reference 93 can be oriented to suit different needs.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except for transitory signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 20 or accessible or connectable thereto. Any application or module herein described may be implemented using computer readable/executable instructions or operations that may be stored or otherwise held by such computer readable media.

Details regarding the different feature extraction systems and methods, that may be associated with the various modules in the software 28, will now be discussed.

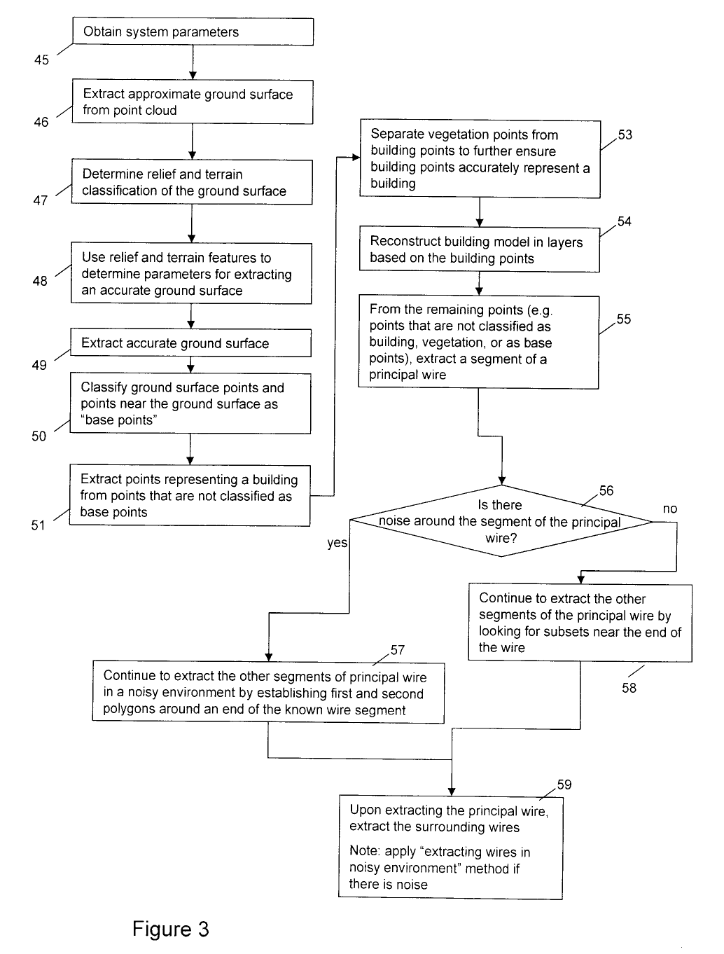

Turning to FIG. 3, example computer executable instructions are provided for extracting various features from a point cloud. The various operations often require system parameters, which may be inputted manually or obtained from a database. These parameters are used to tune or modify operational characteristics of the various algorithms. Non-limiting examples of the operational characteristics include sensitivity, resolution, efficiency, thresholds, etc. The values of the parameters are typically selected to suit the expected types of environment that the point cloud may represent. Thus, at block 45, system parameters are obtained. Although not shown, the parameters may also be obtained throughout the different extraction stages. For example, before executing the instructions of each module, the values of the relevant parameters pertaining to the respective model are obtained.

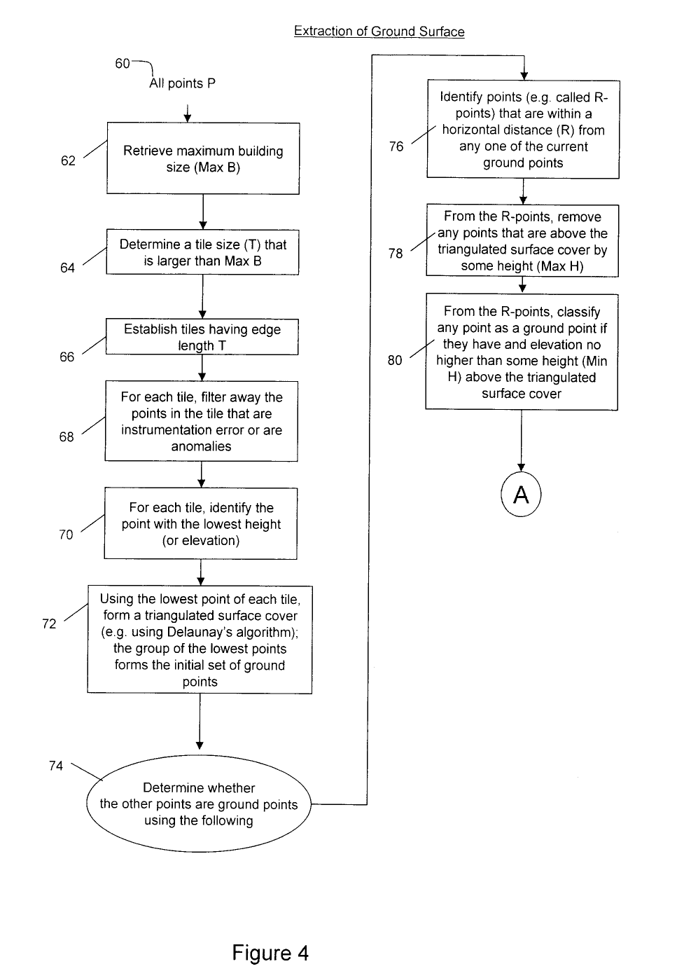

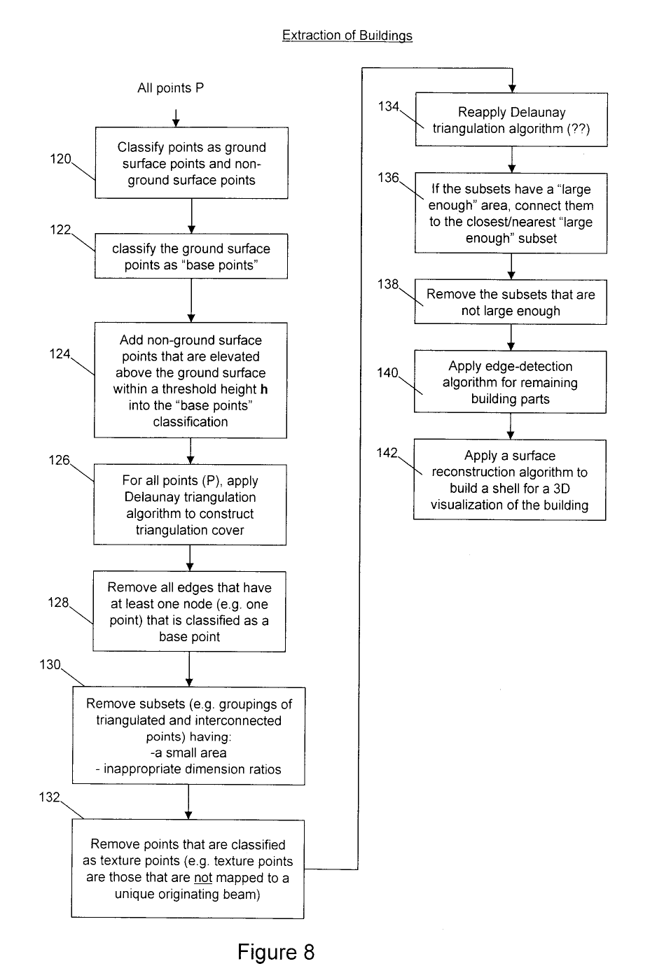

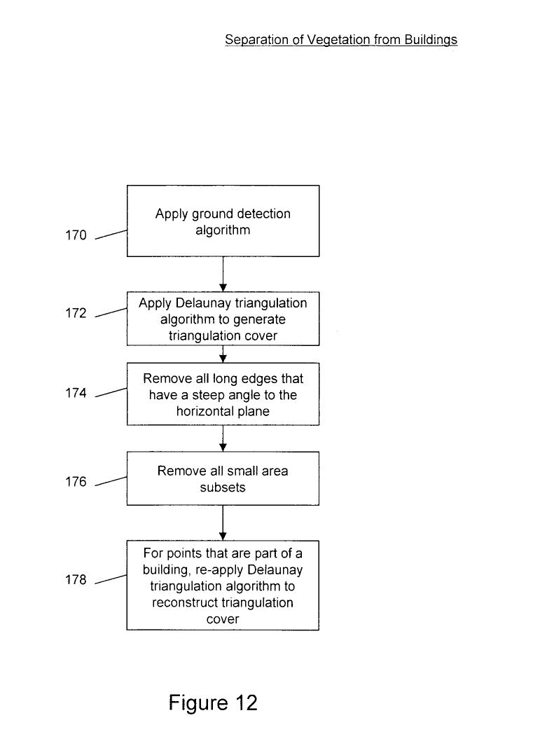

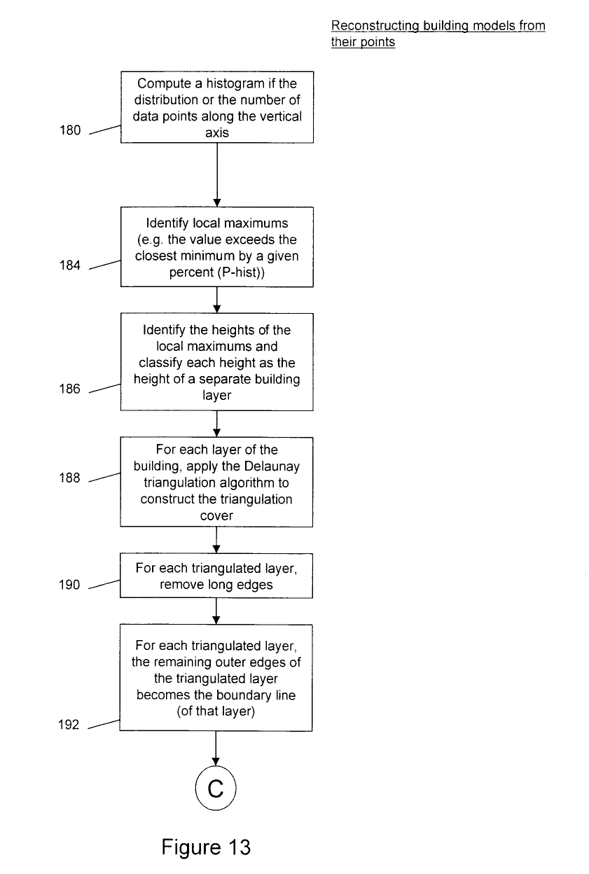

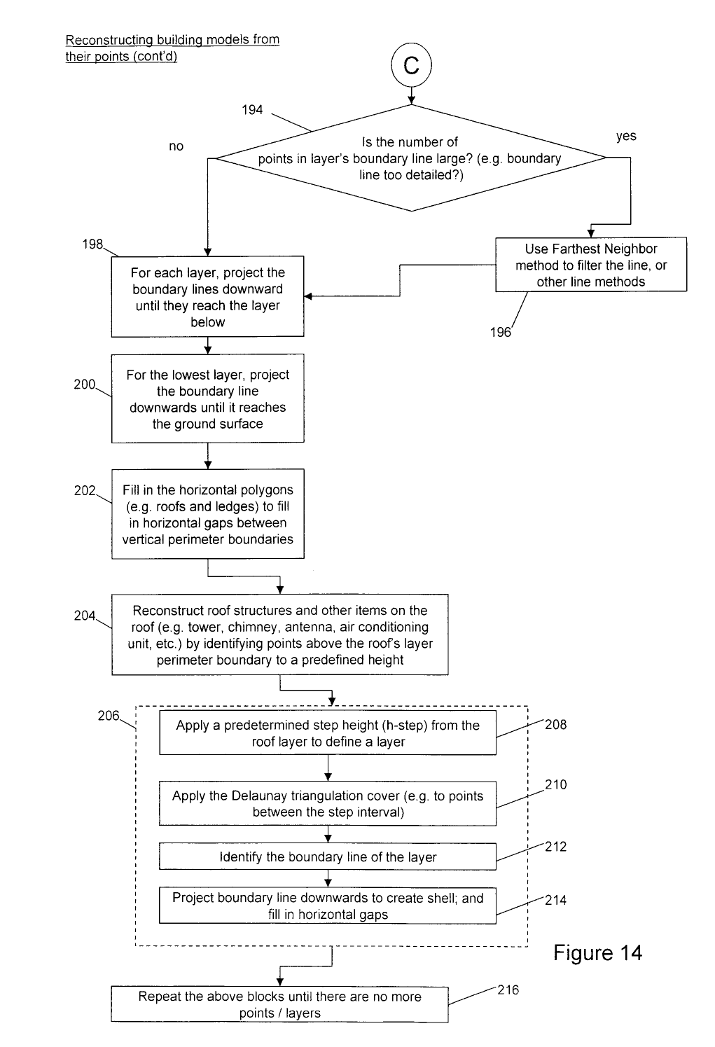

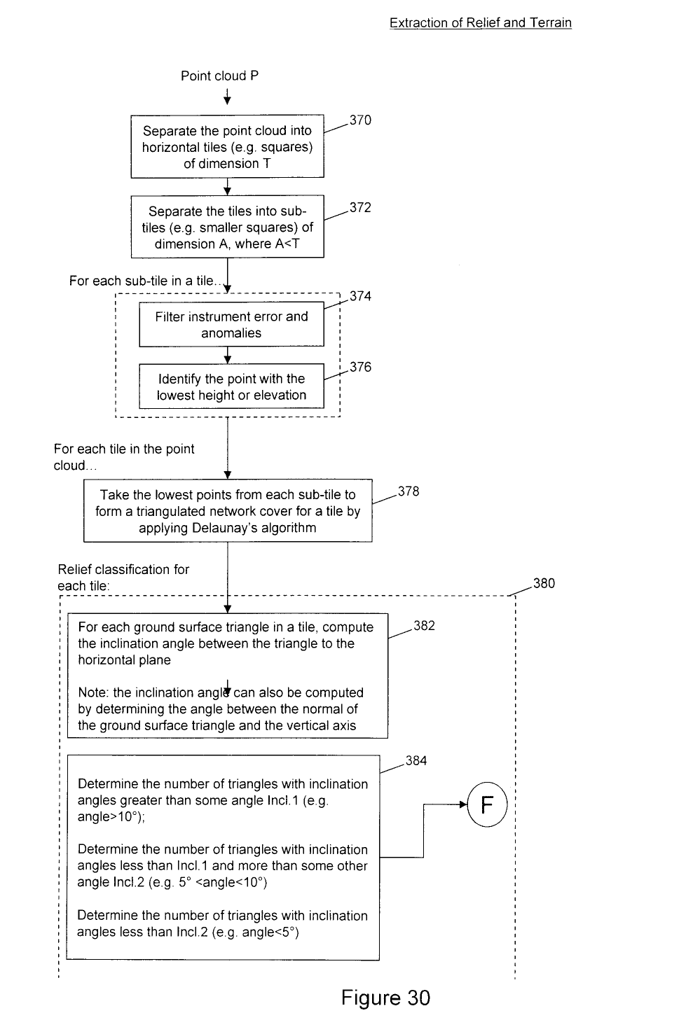

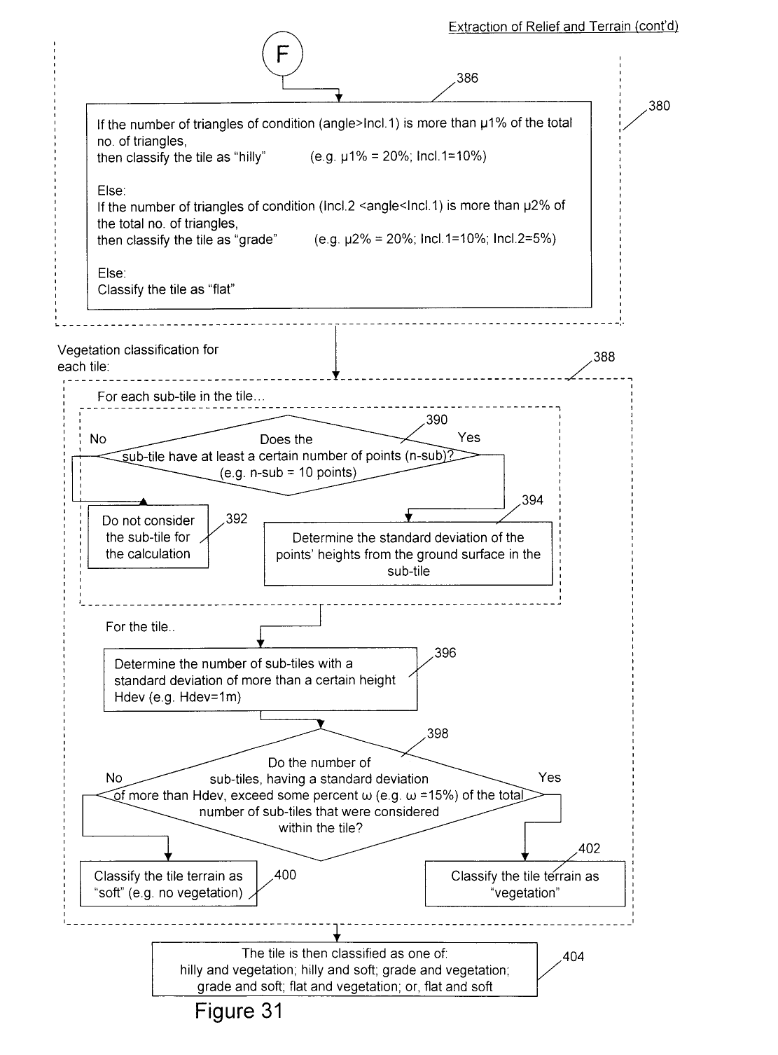

At block 46, an approximate ground surface is extracted from the point cloud P. Based on the approximate ground surface, the relief and terrain classification of the ground is determined (block 47). This is discussed in further detail with respect to module 44 (e.g. FIGS. 30 and 31). At block 48, the relief and terrain classification is used to determine the value of certain parameters for extracting a more accurate ground surface from the point cloud. At block 49, a more accurate ground surface is extracted. This is discussed in further detail with respect to module 32 (e.g. FIGS. 4, 5, 6 and 7). At block 50, ground surface points and points near the ground surface are classified as “base points”. Therefore, the remaining unclassified points within the point cloud P has been reduced and allows for more efficient data processing. At block 51, from the data points that are not classified as “base points”, points representing a building are extracted. This is discussed in further detail with respect to module 34 (e.g. FIG. 8). At this stage, the building points may include some vegetation points, especially where vegetation overlaps or is adjacent to a building. Therefore, at block 53, vegetation points are separated from the building points to further ensure that the building points accurately represent one or more buildings. This is discussed in further detail with respect to module 40 (e.g. FIG. 12). The remaining points more accurately represent a building and, at block 54, are used to reconstruct a building model in layers. This is discussed in further detail with respect to module 42 (e.g. FIGS. 13 and 14).

Upon extracting the ground surface, buildings, and vegetation from the point cloud P, it can be appreciated that the remaining unclassified points have been reduced. Thus, extracting other features becomes easier and more efficient.

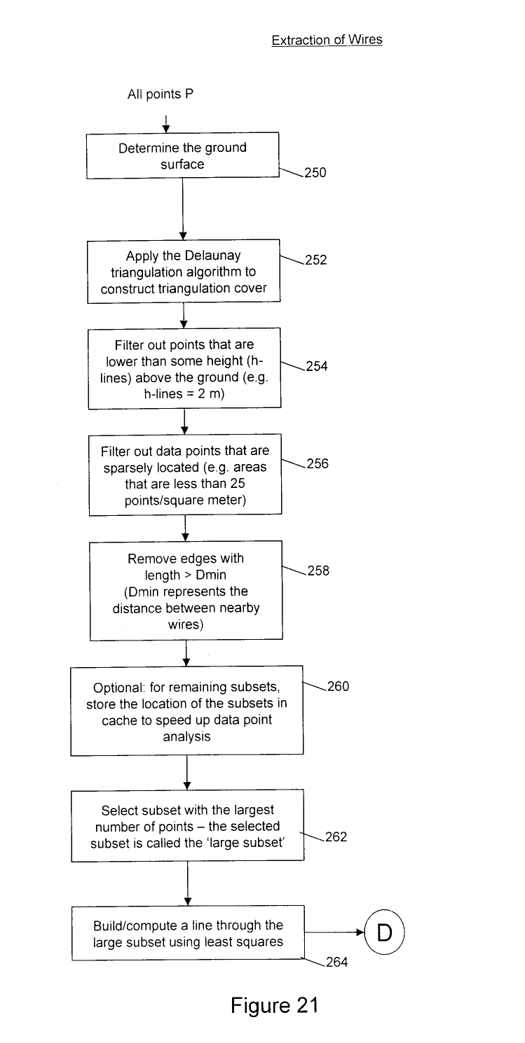

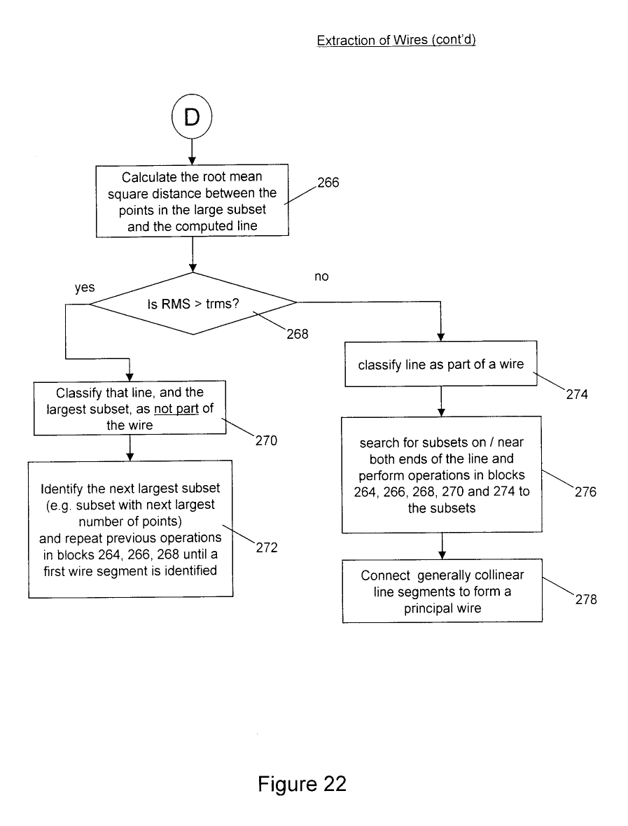

Continuing with FIG. 3, at block 55, from the remaining unclassified points, a segment of a principal wire is extracted. This is discussed in further detail with respect to module 36 (e.g. FIGS. 21 and 22). At block 56, if it is determined that there is no noise surrounding the segment of the wire, at block 58, the other segments of the principal wire are extracted by looking for subsets (e.g. groups of networked points) near the end of the wire segment. After identifying the principal wire, the surrounding wires are located.

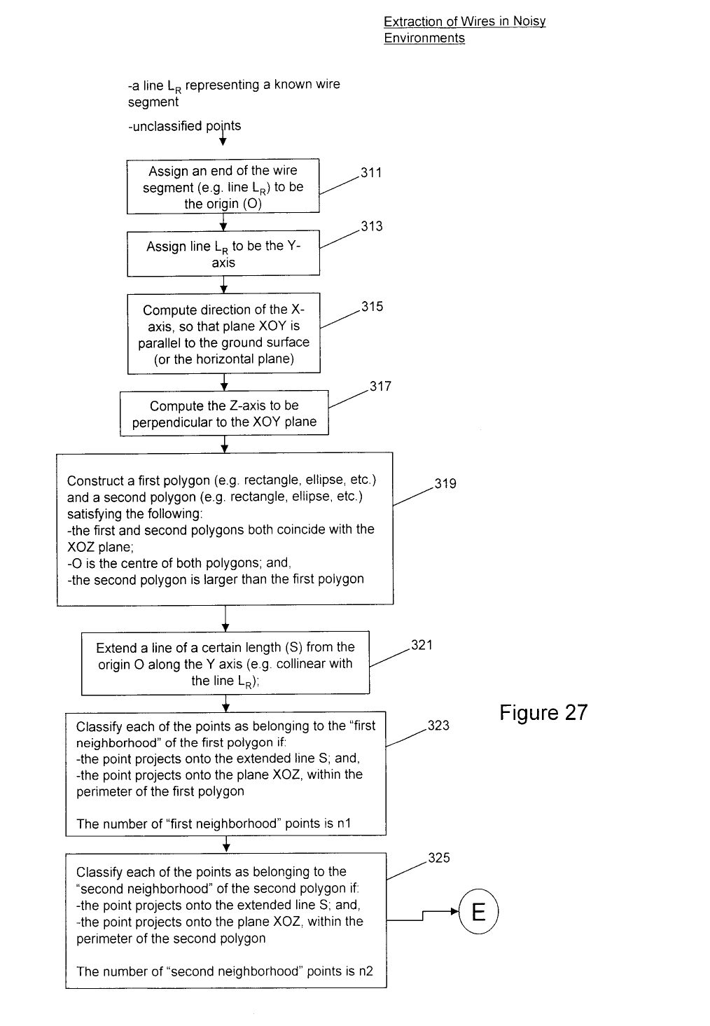

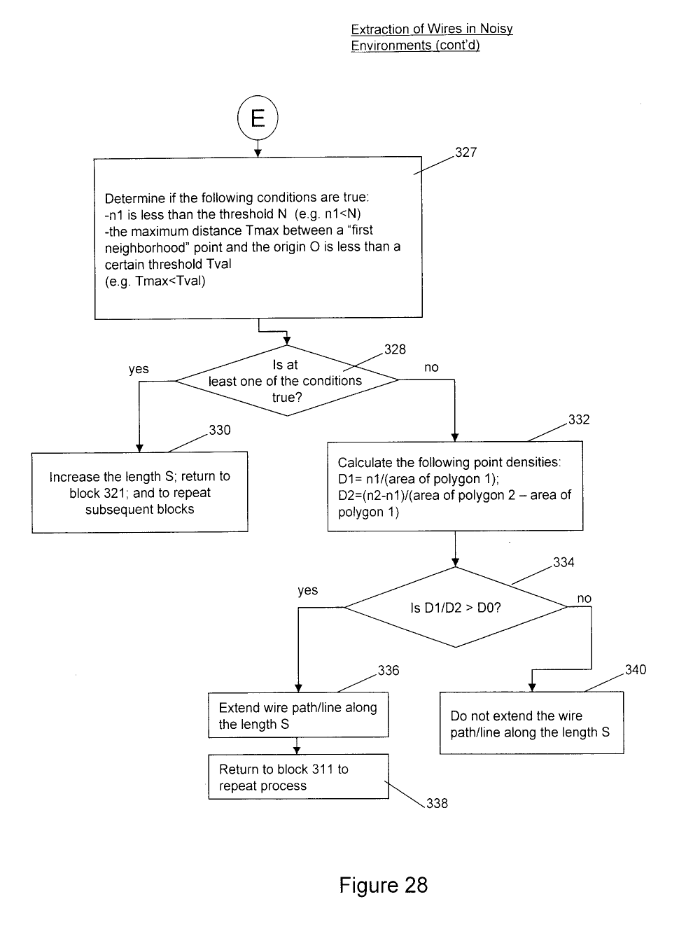

However, if, from block 56, it is determined that there is noise surrounding the segment of the principal wire, then a first and a second polygon are used to extract an extension of the known wire segment. This is discussed in further detail with respect to module 38 (e.g. FIGS. 27 and 28). Similarly, once the principal wire has been extracted, the surrounding wires are extracted at block 59. It can be appreciated that the method of module 38 may also be applied to extract the surrounding wires from a noisy environment, e.g. by using a first and second polygon.

The flow diagram of FIG. 3 is an example and it can be appreciated that the order of the blocks in the flow diagram may vary and may be modified. It can also be appreciated that some of the blocks may be even deleted. For example, many of the blocks may be carried out alone, or in combination with other blocks. Details regarding each of the extraction approaches are discussed further below.

A list of parameters as well as a brief explanation is provided for each module. Some of the parameters may be calculated, obtained from a database, or may be manually inputted. The parameters can be considered as inputs, intermediary inputs, or outputs of the systems and method described herein. The list of parameters is non-limiting and there may be additional parameters used in the different extraction systems and methods. Further detail regarding the parameters and their use are provided below, with respect to each module.

| | |
|---|---|
| P | set of data points (e.g. point cloud) |

Extracting the ground surface (e.g module 32)

| | |
|---|---|
| Max B | maximum building size in the horizontal plane |
| T | tile size |
| R | maximum horizontal distance allowed between a point and a ground point |
| R-points | set of points within a distance R from their respective closest ground point |
| Max H | threshold height above the ground surface, where points above this height |
| | are not extracted as ground points |
| Min H | threshold height above the ground surface, where points below this height |
| | are extracted as ground points |
| A1 | angle between (i) the line connecting a point to the closest ground point; and |
| | (ii) the current ground surface |
| A2 | angle between (i) the line connecting a point to the closest ground point; and |
| | (ii) the horizontal plane |
| Max α | Maximum angle threshold between (i) the line connecting a point to the |
| | closest ground point; and (ii) the current ground surface or the horizontal |
| | plane |

Extracting a building (e.g module 34)

| | |
|---|---|
| base points | set of ground surface points and points near the ground surface |
| h-base | threshold height above the ground surface, where points under the threshold |
| | height form part of the base points |

Reconstructing a building model (e.g. module 42)

| | |
|---|---|
| P-hist | threshold percent that a local maximum on a histogram must exceed the |
| | closest minimum |
| h-step | step height at which layers for structures on the roof are constructed |

Extracting wires (e.g. module 36)

| | |
|---|---|
| h-lines | minimum height that the wires are expected to be located at |
| Dmin | expected distance between nearby wires |
| RMS | Root-mean-square distance between a number of points and a line |
| trms | maximum RMS threshold value that the calculated RMS can have in order |
| | for the points and the line to be classified as part of a wire |

Extracting wires in a noisy environment (e.g. module 38)

| | |
|---|---|
| L_{R} | line segment classified as a wire |
| S | length of proposed wire extension |
| first polygon | polygon coinciding with XOZ plane and encircling the origin O |
| second polygon | polygon coinciding with XOZ plane and encircling the origin O; also larger |
| | than the first polygon with a perimeter that does not overlap the first polygon |
| n1 | number of points counted within the neighbourhood of the first polygon and |
| | the proposed wire extension |
| n2 | number of points counted within the neighbourhood of the second polygon |
| | and the proposed wire extension |
| N | minimum number of points that n1 must have in order to validate data |
| Tmax | maximum distance measured between one of the “n1” points and the origin |
| | O |
| Tval | minimum distance required between the farthest “n1” point and the origin O |
| | to validate the data |
| D1 | density of points within the neighbourhood of the first polygon |
| D2 | density of points within the neighbourhood of the second polygon |
| D0 | minimum density ratio of D1/D2 required for the proposed wire extension to |
| | be extended for length S |

Extracting relief and terrain (e.g. module 44)

| | |
|---|---|
| T | dimension of a tile in the point cloud P |
| A | dimension of a sub-tile within the tile T |
| Incl. 1 | threshold inclination angle between a ground surface triangle to the |
| | horizontal plane |
| Incl. 2 | threshold inclination angle between a ground surface triangle to the |
| | horizontal plane, where Incl. 2 < Incl. 1 |
| μ1 | minimum percentage of triangles in a tile, having inclination angles greater |
| | than Incl. 1, required to classify the tile as hilly |
| μ2 | minimum percentage of triangles in a tile, having inclination angles greater |
| | than Incl. 2 and less than Incl. 1, required to classify the tile as grade |
| n-sub | minimum number of points in a sub-tile required for the sub-tile to be |
| | considered valid for consideration |
| H-dev | minimum standard deviation of the heights of points, above the ground |
| | surface, in a sub-tile required to consider the sub-tile as “vegetation” |
| ω | minimum percentage of sub-tiles in a tile, having a standard deviation of at |
| | least H-dev, required to classify the tile as “vegetation” |

Module 32 comprises a number of computer executable instructions for extracting the ground surface feature from a set of data points with three-dimensional coordinates. These computer executable instructions are described in more detail in FIGS. 4, 5 and 6. In general terms, the method is based on the geometric analysis of the signal returned from the ground and from features and objects above the ground. A characteristic of a typical ground surface point is that it usually subtends a small angle of elevation relative to other nearby known ground points. Using this principle, an iterative process may be applied to extract the ground points. Initially, the lowest points, as indicated by their spatial coordinates, are selected and considered as ground-points. The initial ground points may be determined by sectioning or dividing a given area of points into tiles (e.g. squares) of a certain size, and then selecting the point with the lowest height (e.g. elevation) from each tile. The ground points may then be triangulated and a 3D triangulation network is built. Then, points that satisfy elevation angle criteria are iteratively added to the selected subset of ground points in the triangulated network. The iterative process stops when no more points can be added to the network of triangulated ground points. The selected ground points may then be statistically filtered to smooth small instrumental errors and data noise that may be natural or technological.

Turning to FIG. 4, example computer executable instructions are provided for extracting the ground surface from a set of data with three-dimensional spatial coordinates (herein called the point cloud P). It can be appreciated that distinguishing a set of points as “ground surface” may be useful to more quickly identify objects above the ground surface.

Points in the point cloud P may be considered in this method. At block 62, the maximum building size (Max B) in the horizontal plane is retrieved (for example, through calculation or from a database). The value of Max B may also be provided from a user. For example, Max B may represent the maximum length or width of a building. At block 64, a tile size (T) is determined, where T is larger than Max B. The tile dimension may also be predetermined. At block 66, a grid comprising square tiles having a dimension of T×T is laid over the point cloud P. In this way, the points are grouped or are separated into tiles. The data points are therefore subdivided into sets falling within the boundaries of each tile. The dimensions of each tile should preferably be larger than the largest building foot print to guarantee the presence of one or more ground points in each tile. In other words T should be greater than Max B. By applying such a condition, for example, the risk of mistakenly characterizing a data point on a large warehouse roof as a ground point is reduced.

Continuing with FIG. 4, at block 68, for each set of points within the tile, the points in the tile that are considered to be the result of instrument error or anomalies, are filtered away. In other words large errors, such as gross errors caused by equipment collection malfunction, and recognised by being a multiple number of standard deviations from the mean should be removed. Natural anomalies such as a point coincidentally measured at the bottom of a well or crevasse could also cause such deviations and should be removed. At block 70, for each tile, the data point with the lowest height or elevation is identified from the spatial coordinates of the points. At this stage, if, for example, there is a grid of forty tiles, then there should be forty data points, each being considered the lowest point in their respective tile.

At block 72, using the lowest point of each tile, these lowest points are used to form a triangulated surface cover (also called a triangulated irregular network) using, for example, a Delaunay triangulation algorithm. The group of points with the lowest elevation form the initial set of ground points. It can be appreciated that in the triangulated surface, each of the lowest data points forms a vertex of one or more triangles. By way of background, a triangulated surface or triangulation network typically comprises a number of points, whereby the points form vertices of triangles. Therefore, the triangulated surface includes a number of edges of the triangles and a number of points or nodes, also of the triangles.

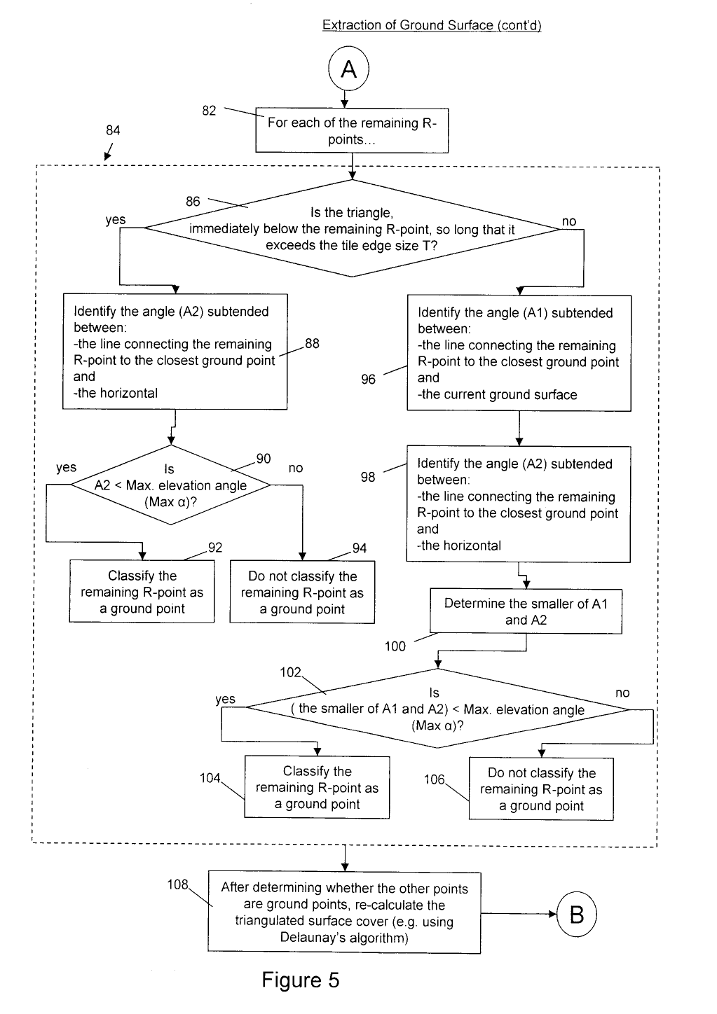

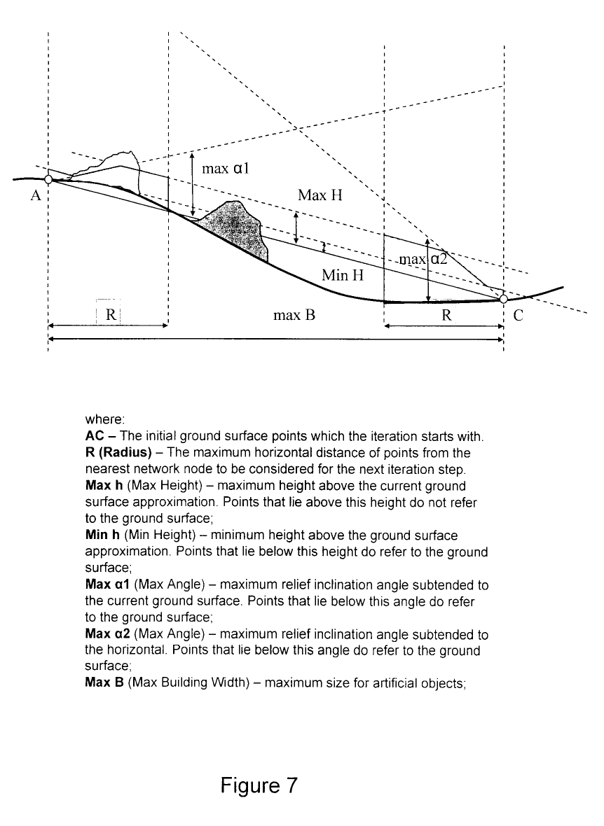

At block 74, it is then determined whether the remaining points in each tile should be classified as ground points. It can be understood that from block 74 onwards, the operations become iterative. In the first iteration, the remaining points are those points that are not the lowest points within their respective tiles. In particular, at block 76, points that are within a certain horizontal distance (R) from any one of the current ground points are identified; these identified points may herein be referred to as R-points. An example of the measurement R is shown in FIG. 7, which extend relative to two ground points, point A and point C. Referring back to FIG. 4, at block 78, from the set of R-points, the computing device 20 removes points that are above the triangulated surface cover by a certain height (Max H). In other words, if an R-point has an elevation above the triangulated surface cover by at least some height Max H, it is not considered a ground point in the current iteration. At block 80, from the set of R-points, the computing device 20 classifies any R-point as a ground point if it has an elevation no higher than a certain height (Min H) above the triangulated surface cover. In other words, if the R-point is close enough to the ground, below the threshold height Min H, then the R-point is considered as a ground point. Referring briefly to FIG. 7, example measurements of the parameters Min H and Max H are shown relative to a ground surface approximation, whereby the ground surface is formed by the line connecting point A and point C. As indicated by circle A, the method of FIG. 4 continues to FIG. 5.

Continuing with FIG. 5, at block 82, the computing device 20 carries out a number of operations in block 84 for each of the remaining R-points (e.g. R-points that do not exceed the elevation Max H, and are not below the elevation Min H). In particular, at block 86, it is determined whether the triangle, that is immediately below the R point, is so long that its length exceeds the tile size edge T. If not, at block 96, the angle A1 is identified, whereby angle Al is defined by or is subtended between (i) the line connecting the remaining R-point to the closest ground point, and (ii) the current ground surface (e.g. the current triangulated surface cover). At block 98, the angle A2 is also identified, whereby angle A2 is defined by or is subtended between (i) the line connecting the remaining R-point to the closest ground point, and (ii) the horizontal. At block 100, the computing device 20 determines which of A1 and A2 is smaller. Then, at block 102, it is determined whether the smaller of A1 and A2 is less than the maximum elevation angle (Max α). If so, at block 104, the remaining R-point is classified as a ground point. If the smaller angle of A1 and A2 is larger than Max α, then the remaining R-point is not classified as a ground point.

The basis of the above analysis is that if a point is at a steep angle from the known ground surface, and from the horizontal, then it is likely that the point may not be a ground point.

If, at block 86, the distance between the remaining R-point and closest ground point is longer than the tile size T, then at block 88, the angle A2 is identified. In other words, the angle A1 is not used since, if the line connecting the remaining R-point and the closest ground point is long, the angle A1 may likely not accurately approximate the ground surface. At block 90, it is determined whether or not the angle A2 is less than the maximum elevation angle (Max α). If so, then the remaining R-point is classified as a ground point in block 92. If not, the R-point is not classified as a ground point in block 94. As discussed above, the blocks within block 84 are applied to each of the remaining R-points to identify which of these are to be classified as ground points.

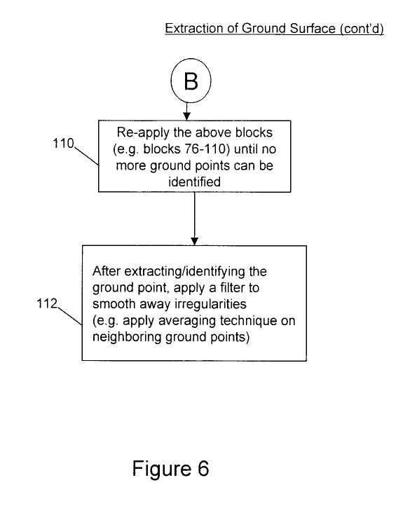

Continuing with FIG. 5, at block 108, after determining whether the other points are ground points, the triangulated surface cover (e.g. ground surface) is re-calculated taking into account the newly classified ground points. As indicated by circle B, the method of FIG. 5 continues to FIG. 6.

In FIG. 6, at block 110, the operations of determining whether other points are ground points is repeated in an iterative process. In particular, blocks 74 to 110 are repeated. The process stops re-iterating itself when no more ground points can be identified. When no more ground points can be identified, at block 112, a filter may be applied to smooth away irregularities. In one example, the filter may include an averaging technique applied to neighbouring ground points. An example of an averaging technique is to use a weighted average of the heights of surrounding points, which is weighted inversely with the square of their distance away. It is known that inverse square weighting attributes closer points to have a larger influence and more distant points to have a very small influence.

It can be appreciated that the above uses pre-defined criteria threshold values namely: tile edge size (T), maximum building width (Max B), maximum horizontal distance for each iteration (R); maximum elevation above the network (Max H), minimum elevation above the network (Min H) and maximum elevation angle (Max α). These threshold values can be changed to fine tune the efficiency of the process and the accuracy of the resulting ground surface, and how closely it approximates the actual ground surface. An example illustration of these parameters is provided in FIG. 7.

Certain threshold values may result in efficient and accurate results for flat terrain while others may be required to obtain efficient and accurate results for hilly terrain. Similarly heavily treed areas, high density urban areas and agricultural areas and other typical terrain types will require different sets of parameters to achieve high efficiency and accuracy in their resulting ground surface approximations. For example, the maximum angle max α is set to be larger for hilly terrain to accommodate the steeper gradients. The maximum angle max α is set to be smaller (e.g. less than 2°) for flat terrain. The relief and terrain definition module 44, which will be discussed further below, can be used to automatically determine the relief and vegetation classification of a tile (or data set) so that different sets of criteria can be automatically applied in the ground surface extraction module 32.

Upon completion of the ground extraction iteration, the points representing ground are identified in the point cloud and may be excluded from further feature extraction, if desired.

Turning to FIG. 8, example computer executable instructions for extracting one or more building models from a point cloud P are provided. It can be appreciated that these computer executable instructions may form part of module 34. The method may take into account that the data points which represent a certain building are isolated in 2D or 3D space and are elevated above the ground surface. In general, the method may include: separation of points reflected from the ground surface and points reflected above the ground surface; segmentation of local high-density XY-plane projected groups of points that are above the ground surface; analysis of each group in order to find out if the points within a group belong to an object that represents a building; noise-filtering of building related points (e.g. removal of vegetation points); and reconstruction of a building model out of the point cloud that represents a certain building. Details are described below with respect to FIG. 8.

The set of points within the point cloud P are used as an input. At block 120, points are classified as ground surface points and non-ground surface points. The classification of ground surface points may take place using the instructions or operations discussed with respect to module 32, as well as FIGS. 4, 5 and 6. In another example embodiment, the ground surface points are obtained. For example, the ground surface points have been previously identified in the data by another computing device, or by a user. At block 122, the ground surface points are also classified as “base points”. At block 124, non-ground surface points that are elevated above the ground surface within a threshold height (h-base) are classified as “base points”. In other words, non-ground points that are near the ground surface, within some height h-base, are also considered base points. In one example embodiment, the threshold height h-base may represent the desired minimum building height (e.g. half of a storey) to filter out points that may not belong to a building. Then, for all non-base points in the point cloud P, the Delaunay triangulation algorithm is applied to construct a triangulated surface.

By way of background, Delaunay triangulation is often used to generate visualizations and connect data points together. It establishes lines connecting each point to its natural neighbors, so that each point forms a vertex of a triangle. The Delaunay triangulation is related to the Voronoi diagram, in the sense that a circle circumscribed about a Delaunay triangle has its center at the vertex of a Voronoi polygon. The Delaunay triangulation algorithm also maximizes the minimum angle of all the angles in the triangles; they tend to avoid skinny triangles. Although the Delaunay triangulation algorithm is referenced throughout this and other methods described herein, it can be appreciated that other triangulation algorithms that allow a point to form a vertex of a triangle are applicable to the principles described herein. More generally, triangulation algorithms that form triangulated surfaces are applicable to the principles described herein.

At block 128, all edges that have at least one node (e.g. one point) that is classified as a base point are deleted or removed. In this way, for all objects that are above the ground surface, the grouping of data points representing each of the objects are separated from the ground surface. Thus a number of subsets (e.g. grouping of data points) are created, since they are no longer connected to one another through the layer of base points.

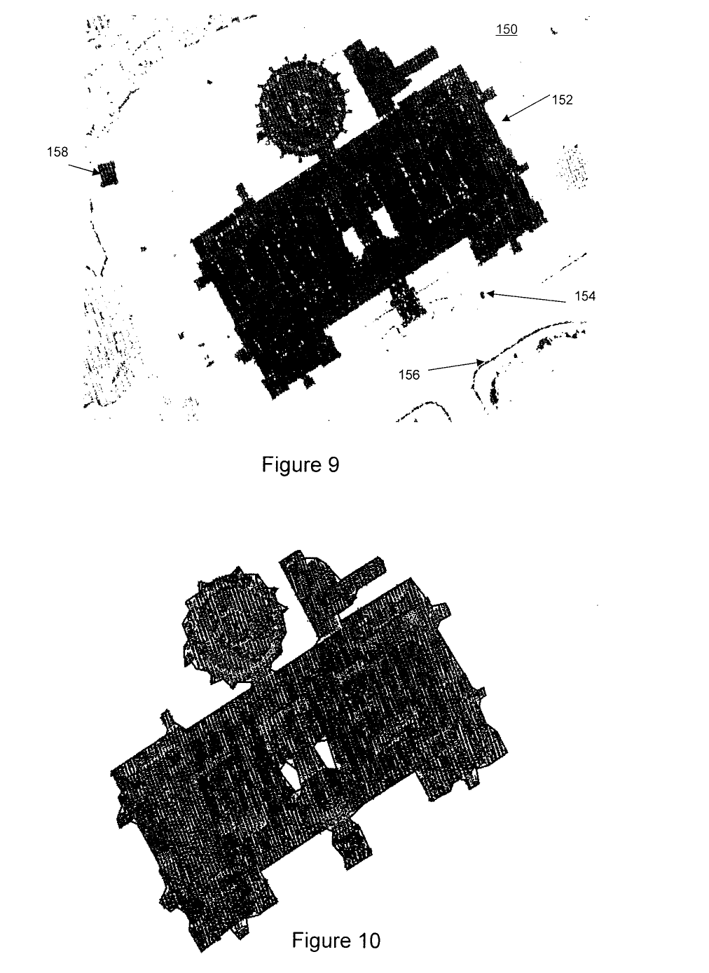

At block 130, subsets having a small area or inappropriate dimension ratios are deleted or removed. For example, turning to FIG. 9, a planar view of a point cloud 150 is provided, illustrating the foot-print of a building 152. Objects 154 and 158 with a small area are removed. Other objects, such as a curb 156, which has a high length-to-width ratio, are also removed. In an example where building roofs are measured, the small area refers to the area of a building as viewed from above. In particular, “small” refers to areas that are smaller than the smallest building area as viewed from above. In other words, the smallest plan-view area of a building can be used to set a threshold for determining small subsets.

At block 132, the computing device 20 removes points that are classified as texture points, which are data points that indicate a surface is a textured surface. It can be appreciated that the textured points may not necessarily be deleted, but rather identified as non-building points. Generally, buildings have smooth surfaces, while natural objects, such as vegetation, have textured surfaces. In this way, the removal of textured points removes vegetation. For example, if the data points were collected using LiDAR, and if a single laser beam was emitted and hit a smooth surface (e.g. brick wall), then a single return beam would reflect back from the smooth surface. However, if a single laser beam was emitted and hit a textured surface (e.g. foliage of a tree), there would be multiple reflections and several return beams (or texture points) would be generated. Therefore, in the example of LiDAR collected data, texture points may be those points that are not mapped to a unique originating beam. Texture information in LiDAR data can be stored in .LAS files. The files store an attribute which indicates the number of returns for each laser measurement. Based on the number of returns, the texture information is obtained.

Continuing with FIG. 8, after removing the textured points, at block 134, the Delaunay triangulation algorithm may be re-applied to reconstruct the triangulated surface and repair holes in the network which had been created by point removal.

It can be appreciated that, at this stage, there may be a large-area subset of triangulated and interconnected points (e.g. representing the main building) in the triangulated surface (also called triangulated network) that may be surrounded by smaller-area subsets of triangulated and interconnected points (e.g. representing extensions of the main building). The area of the subsets are viewed from above and, thus, refer to plan-view areas. At block 136, if it is determined that the subsets have a “large enough” area, they are connected to the closest or nearest “large enough subset”. In this way, different parts of a building may be connected together. Alternatively, if the smaller-area subsets are “close enough” to the largest subset (e.g. the main building) and they are also “large enough” to be considered a building, then smaller-area subsets are added to the largest subset. It can be appreciated that the values or range of values defining “large enough” and “close enough” may be adjusted to vary the sensitivity of the filtering. The threshold value for determining a “large enough” subset can be set according to the smallest acceptable plan-view area that characterizes a building. A threshold value or a threshold distance for defining “close enough” should be selected so that individual buildings (e.g. residential houses) are not mistakenly linked together. This method may also be applicable for extracting buildings of a complex shape, such as with internal clearings or patios. The method may also be used to retain small structural details, such as pipes and antennas.

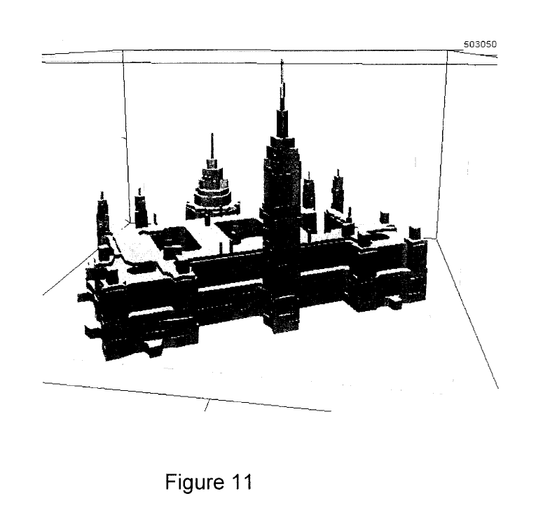

At block 138, subsets of triangulated points that are considered to be not “large enough” are removed from the set of points for under consideration to identify a building. At this stage, the subset of triangulated points define a building. Optionally, at block 140, an edge-detection algorithm may be applied to the subset of points to outline the building. For example, FIG. 10 shows the subset of points belonging to the building only, with other points removed. At block 142, a known surface reconstruction algorithm may be used to build a shell of the building. The reconstructed surfaces of the building is used to illustrate the building in a 3D visualization, which can be displayed on the display device 18. An example of a reconstructed 3D visualization of a building model is shown in FIG. 11.

In another aspect of extracting features from a point cloud, when determining the extent of a building, vegetation on or near a building may obscure the building itself, and give a false visualization. Turning to FIG. 12, example computer executable instructions are provided for separating vegetation from buildings, which is done prior to edge detection and rendering. Such instructions may form part of module 40. In general, a method is provided which separates the points reflected from the buildings and the points reflected from nearby or adjacent vegetation. It is assumed that the ground points have already been extracted, for example, using the method described with respect to FIGS. 4, 5 and 6. The method described in FIG. 12 is based on the analysis of the structure of the triangulated surface or triangulated network, which is built out of the points reflected from buildings as well as vegetation that is adjacent to or nearby the buildings. Trees can be recognized by the large number of steep (e.g. vertical-like) edges they produce in such a triangulated surface. In contrast, the roofs of the buildings may be characterized by a small quantity of such steep edges. In general, to separate building and vegetation points, steep edges are removed from the triangulated surface. The removal of steep edges can lead to the creation of single or lone points in the vegetation areas, which can be subsequently removed. As a result, part of the triangulated surface, which also includes vegetation data points, will be decomposed to a number of smaller parts and single points. These smaller areas, e.g. representing vegetation, can be removed. The remaining areas, which are more connected, may define the buildings.

In particular, in FIG. 12, at block 170, a ground detection algorithm is applied to separate ground surface points from non-ground surface points. In another example embodiment, the ground surface points are obtained. For example, the ground surface points have been previously identified in the data by another computing device, or by a user. At block 172, the Delaunay triangulation algorithm is applied to construct a triangulated surface. At block 174, all long edges that have a steep angle to the horizontal plane (e.g. greater than 45°) are removed from the triangulated surface. In an example embodiment, long edges are defined relative to the shortest edge within the triangulated surface. In particular example, if a given edge is at least five times longer than the shortest edge, then the given edge is considered a long edge. In this way, the groups of points belonging to vegetation are separated. At block 176, the small area subsets (e.g. representing vegetation) are removed. At this stage, the remaining points are considered to be points of a building. At block 178, the Delaunay triangulation algorithm may be re-applied to the remaining points in the triangulated surface to reconstruct another triangulated surface.

It may appreciated that the example instructions of FIG. 12 may be used in combination with the building extraction method described with respect to FIG. 8. In one example embodiment, between blocks 128 and 130, or between blocks 130 and 132, or between blocks 132 and 134, the method of separating vegetation from a building, as described with respect to FIG. 12, may be inserted. Any combination that allows for both the building to be extracted and for the vegetation to be separated from the building is applicable to the principles described herein.

In another module, the building reconstruction module 42 includes computer executable instructions to reconstruct the structure or shell of a building model from the data points. In particular, FIGS. 13 and 14 show example computer executable instructions for reconstructing building models. The method may be based on piecewise stationary modeling principles. The building may be split or divided into horizontal layers (or floors), and it may be assumed that the horizontal area of the building remains the same within each layer. To identify the different layers of the building, a frequency histogram of the distribution of the data points along the vertical axis for each building is computed. The concentration of points projected on the histogram's axis identifies any flat horizontal parts of the buildings, such as the roofs or ledges. The heights of the histogram's peaks represent a high concentration of points, which can be used to define the boundaries between the layers. Perimeters of each layer of the building are computed, and from each layer perimeter, walls are projected downwards. This constructs a model consisting of vertical and horizontal polygons which represents the building shell. Based on the building shell, the main spatial and physical parameters of the building, such as linear dimensions and volume, can be obtained.

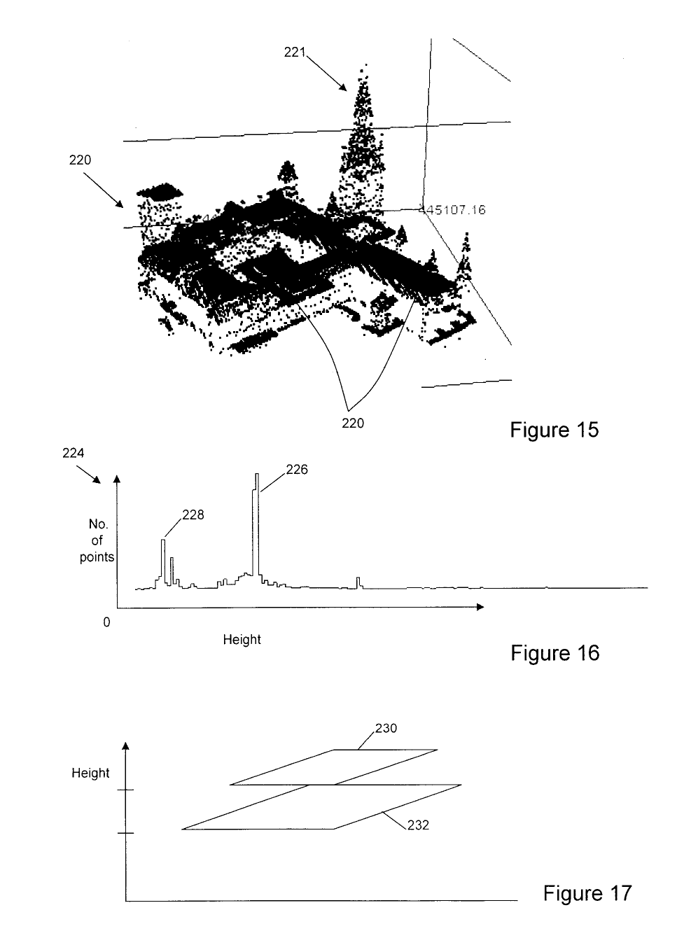

Turning to FIG. 13, it can be appreciated that the inputted data points are considered to be already classified as building points of a certain building. For example, a point cloud 220 of building points is shown in FIG. 15. It can be appreciated that the roof top 222 has a higher concentration of points (e.g. denser or darker point cloud) since the data points were collected from overhead, for example, in an airplane. At block 180, a histogram of the distribution or the number of data points is computed along the vertical or elevation axis. An example of such a histogram 224 is shown in FIG. 16. The peaks 226, 228 of the histogram represent a high density of data points at a given height, which indicates the height of the flat parts (e.g. roofs, ledges) of a building. The histogram may also represent at what heights the horizontal or planar cross-sectional area of the building is changing.

At block 184, the local maximums of the histogram are identified. For example, a value on the histogram may be considered a local maximum if its value (e.g. number of points) exceeds the closest local minimum by a given percent (P-hist). Adjusting the value of the given percent P-hist may adjust the sensitivity and level of detail of the building's reconstruction. For example, a smaller value for P-hist would mean that the building reconstruction may be more detailed, while a larger value for P-hist would mean that the building reconstruction is less detailed. At block 186, the heights of the local maximums are identified. Further, each height of a local maximum is classified as the height of a separate building layer. In this way, the heights of the different building layers are identified.

At block 188, for each layer of the building, the Delaunay triangulation algorithm is applied to construct a triangulated surface for the building layer, called a triangulated layer, for example, using the horizontal coordinates XY. At block 190, for each triangulated layer, the long edges within the triangulated layer are removed. In one example embodiment, a long edge is one that would be longer than the known length of an internal courtyard of a building, such that the long edge may extend across and cover such a courtyard. In other words, an edge that is longer than a threshold (e.g. set b the length of the building) is considered a long edge. The remaining outer edges of the triangulated network are used to build the layer perimeter boundary lines. In particular, at block 192, for each triangulated later, the outer edges of the triangulated layer become the boundary line of that layer. As an example, FIG. 17 shows two triangulated layers 230 and 232 having different heights and a different area. In the example, the layers 230 and 232 have rectangular boundary lines. As indicated by circle C, the method of FIG. 13 continues to FIG. 14.

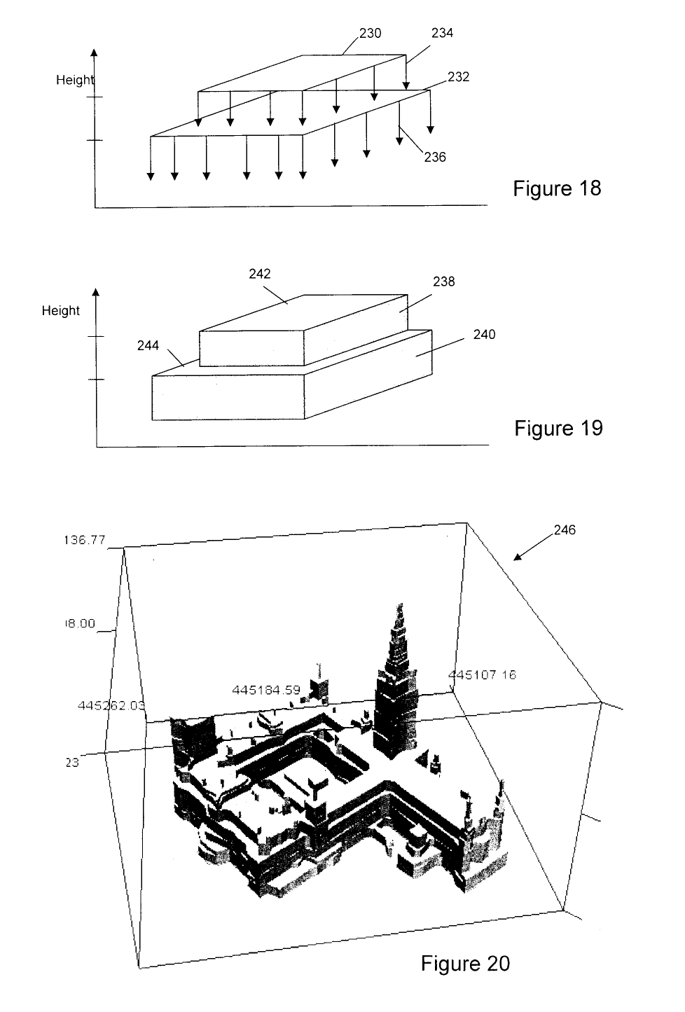

In FIG. 14, at block 194, the computing device 20 determines whether or not the number of points in the boundary line is large (e.g. the number of points exceeds a threshold). In other words, it is determined whether or not the boundary line is too detailed. If so, at block 196, a farthest neighbour method may be used to filter or smooth the line. An example of the farthest neighbour method is the Douglas-Peuker line filtering or line simplification method, which is known as an algorithm for generalizing line features while preserving the overall shape of the original line. Alternatively, other line filtering or smoothing methods may be used. From block 196, the method may proceed to block 198. It can be appreciated that, if the line was not too detailed, then block 194 may proceed to block 198. At block 198, for each layer, the boundary lines are projected downwards until they reach the layer below. At block 200, for the lowest layer, its boundary line is projected downwards until it reaches the ground surface. For example, in FIG. 18, the boundary lines of layer 230 is projected downwards (234) until it reaches layer 232 below. It can be appreciated that projections may be vertical, substantially vertical, or at angles to the horizontal plane. The boundary lines of layer 236 (e.g. the lowest layer) is projected downwards until it reaches the ground. As can be seen in FIG. 19, the projections represent the walls 238 and 240 of the building.

Returning back to FIG. 14, at block 202, the horizontal polygons (e.g. roofs, ledges) are filled in. In other words, the horizontal gaps between the walls are filled in. For example, as shown in FIG. 19, the horizontal surfaces 242 and 244 may be filled in to represent the roofs and ledges of a building.

Continuing with FIG. 14, at block 204, the computing device 20 reconstructs roof structures and other items on the roof (e.g. tower, chimney, antenna, air unit, etc.) by identifying points above the roof layer's perimeter boundary. In other words, points that are above the area of the roof are identified. For example, turning briefly to FIG. 15, the group of points 221 are above the roof layer.

A set of operations 206 are applied to construct layers above the roof. In particular, at block 208, a predetermined step height (h-step) is added to the roof layer, thereby defining the height of a new layer above the roof. It can be appreciated that using a smaller value for the parameter h-step may allow for higher resolution or more detail of the roof structures. An example value for h-step is 5 meters, which would be suitable to construct a rough block of a building's steeple. An example value of h-step=0.5 meters would construct a more detailed building steeple. At block 210, the Delaunay triangulation algorithm is applied to the points in the layer, that is, all points which are were found to be between the step intervals. The boundary line (e.g. outer edge) of the layer is then identified (block 212). At block 214, the boundary line is projected downwards to the layer below to create a shell. Further, the horizontal gaps may also be filled in. It can be appreciated that in the first iteration, the boundary line of the roof structure is projected downwards to the roof layer. At block 216, the set of operations 206 are repeated for the points above the layer. In other words, a higher layer is formed at a predetermined step height above the previous layer (block 208), before proceeding to blocks 210, 212 and 214 again. The set of operations 206 reiterate themselves until there are no more points that are located above the roof, so that no more layers can be formed (block 216).

It can be seen that the above operations may be used to reconstruct a building structure from data points with three-dimensional spatial coordinates. For example, in FIG. 20, a building structure 246, including steeples, posts, ledges, towers, etc., may be computed using the above described method and displayed in detail. It can also be appreciated the method described with respect to FIGS. 12, 13 and 14 may be used in combination with the building extraction method, described with respect to FIG. 8. In particular, the building reconstruction method may be used in combination with or in place of blocks 140 and 142 of FIG. 8.

In another aspect, module 36 may include computer executable instructions for extracting wires (e.g. power lines, cables, pipes, rope, etc.) from a data point cloud P. Power-lines may generally be made of a finite number of wires, which can go in parallel, in various directions, or approach their target objects (e.g. poles, transformer stations, etc.). Reconstruction of the whole power-line may be more feasible after reconstructing each wire separately. The term “wires” as used herein may refer to various types of long and thin structures.

In general, the reconstruction of wires begins with separating the points from the ground surface, for example, using the method described with respect to FIGS. 4, 5 and 6. It may also be assumed that the point cloud contains points that belong to a wire. Segmentation or identification of points that belong to a single wire is an important part of the described method. First, a principle wire is identified based on the density of points. The segments of the principal wire are identified along the length, and then the segments are connected to form the length of the principal wire. After identifying the principal wire, ancillary wires surrounding the principal wire are identified by examining the projection of points on to a plane perpendicular to a plane of the principal wire. A higher density of projected points on to the plane indicates the presence of surrounding wires. Segments of the surrounding wires are then identified and connected together in a similar manner to the construction of the principal wire.

Turning to FIG. 21, example computer executable instructions for extracting wires from a point cloud are provided. At block 250, using the set of data points in the point cloud P, the ground surface is determined or obtained. For example, the ground surface points obtained as they have been previously identified in the data by another computing device, or by a user. At block 252, the Delaunay triangulation algorithm is applied to the point cloud to construct a triangulated surface. At block 254, points that are lower than some height (h-lines) above the ground surface are removed or filtered out. In this way, points that are near the ground are removed, since it may be assumed that the wires must be of a certain height. For example, the parameter h-lines may be 2 meters. At block 256, data points that are sparsely located are also removed or filtered out. It is assumed that wires have a certain point density. In one example, the point density of wires should be at least 25 points per square meter.

At block 258, edges in the triangulated network with length greater than a predetermine length (Dmin) are removed or filtered away. The parameter Dmin represents the distance between nearby (e.g. parallel-running) wires. The parameter Dmin is determined using a known standard or is measured. For example, for power lines, it may be known that parallel-running wires must be at least some distance apart from one another. It can be appreciated that removing edges longer than Dmin ensures that separate wires are not mistakenly represented as a single thick wire. After removing the long edges, at this stage, there are multiple subsets (or groupings) of triangulated points.

At block 260, for the purpose of speeding up data point analysis, the locations of the subsets may be stored in memory. In this way, the grouping of points, as identified in part by their location, may be quickly retrieved for analysis.

Continuing with FIG. 21, at block 262, the computing device 20 identifies and selects the subset with the largest number of triangulated points. This selected subset may be herein referred to as the “large subset”. The largest subset is used as a starting data set, since it may likely be part of a wire. At block 264, a line passing through the largest subset is computed using a least squares calculation. It can be appreciated that other line fitting algorithms may be used. As indicated by circle D, the method of FIG. 21 continues to FIG. 22.

Continuing with FIG. 22, at block 266, the root mean square (RMS) distance between the points in the subset and the computed line of block 264 is determined. The RMS distance is used to determine the concentration of points or location of points relative to the line. A large RMS distance may indicate that the points in the subset are spread out and do not closely represent a line (or a wire). A small RMS distance may indicate that the points in the subsets are closer together and more closely represent a line (or a wire). At block 268, it is determined whether or not the RMS distance is greater than a threshold (trms). The value for the threshold trms may be determined by a user, empirical data, or through some other methods. If the RMS distance of the subset is greater than the value of the threshold trms, then the line and its associated subset are classified to be not part of the wire (block 270). At block 272, the computing device 20 then identifies the next largest subset (e.g. the subset with the next largest number of points) and repeats the operations set forth in blocks 264, 266, 268 and optionally blocks 270 and 272, until a subset is identified having a computed line and RMS distance that is less than or equal to the threshold trms.

If, at block 268, the RMS distance of a certain subset is not greater than the threshold trms, then at block 274, the computed line of the certain subset is classified as part of the principal wire. Once the first segment of the principal wire is identified, at block 276, the computing device 20 searches for subsets that are on or near either ends of the line. Subsets that are on or near the end of a line are within an acceptable distance from the end of the wire. Further, the subsets preferably have a length that is oriented the same way as the wire. Once such subsets are identified, the operations set forth in blocks 264, 266, 268, 270 and 274 are applied to classify whether or not these subsets form part of the wire. In this way a number of subsets may be sequentially identified as subsets belonging to or classified as part of a principal wire.

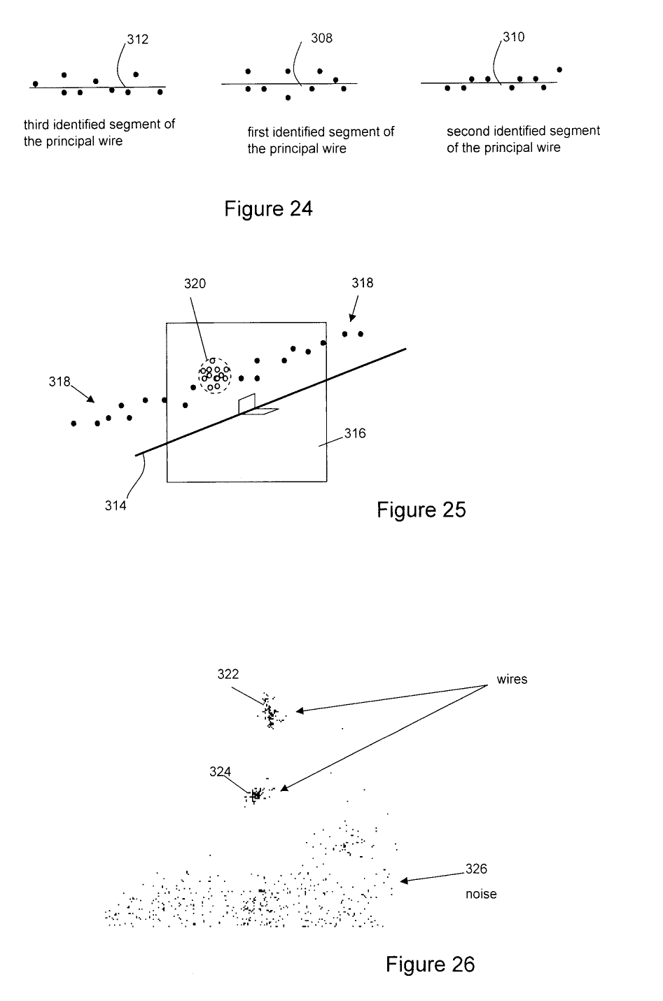

Turning briefly to FIG. 24 an example of different segments of a principal wire is shown. The first classified segment 308 of the principal wire is shown. On one end of the first segment 308, the second classified segment 310 of the principal wire is shown. On the other end, the third segment 312 of the principal wire is shown. It can be appreciated that the segments 308, 310, 312 may be somewhat collinear, since the locations of the subsequent-classified segments were identified relative to the ends of previous-classified segments of the principal wire.

Turning back to FIG. 22, at block 278, the generally collinear line segments are connected to one another to form a principal wire. In this way, the principal wire is extracted from the point cloud P.

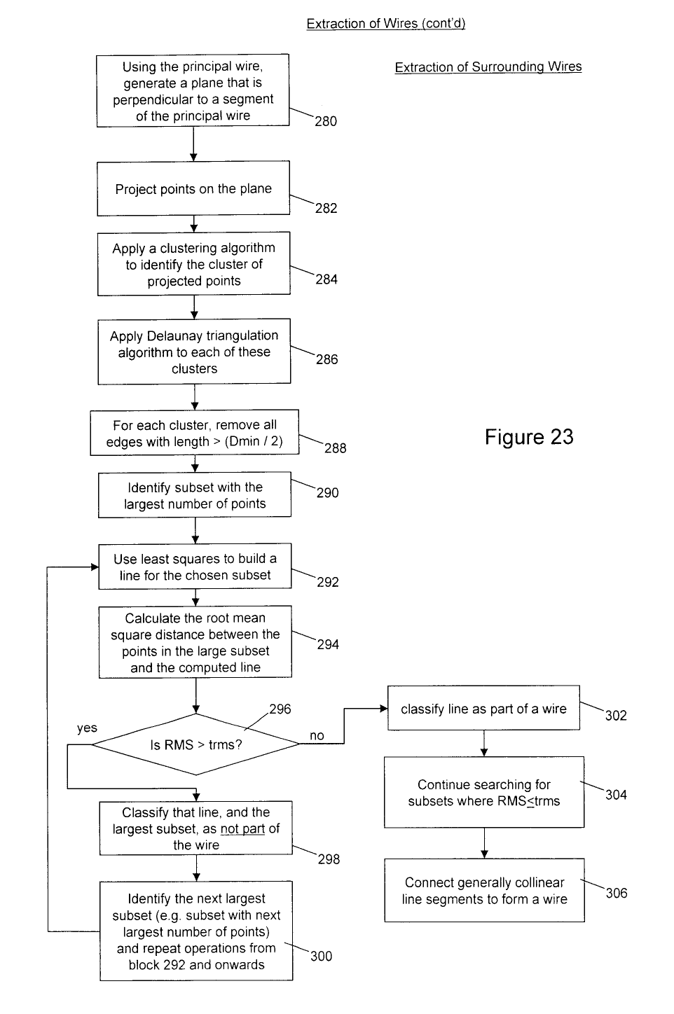

Turning to FIG. 23, example computer executable instructions are provided to extract or identify ancillary wires surrounding the principal wire. After the principal wire is identified, at block 280, a plane that is perpendicular to a segment of the principal wire is generated. At block 282, points that have projections on to the plane are identified. At block 284, a clustering algorithm (e.g. nearest-neighbour, k-means, fuzzy clustering, etc.) may be applied to identify the cluster of projected points, which would assist in identifying which points may make-up the ancillary wires. In particular, a cluster of points likely indicated the presence of an individual wire. It can be appreciated that the projection of the points are distinct from the points themselves, since the projections lie on a common plane perpendicular to the principal wire.

For example, turning to FIG. 25, a plane 316 is shown in perpendicular orientation to the principal wire 314. There may be a number points 318 that may have projections 320 on the plane 316. If the projections 320 are close together, then they may indicate the presence of ancillary wires. Turning to FIG. 26, another example of points being projected onto a plane is shown. The dense clusters or groups of points projections 322 and 324 indicate the presence of two separate ancillary wires. The sparse points 326 indicate noise.

Continuing with FIG. 23, at block 286, the Delaunay triangulation algorithm is applied to points (not the projections of the points) in each of the clusters or groupings. In this way, the points of each cluster or grouping are networked or connected together. In other words, the networked points in a cluster form a subset.

It can be appreciated that the following operations are applied to each of the clusters, since each cluster potentially represents an ancillary wire. At block 288, for each subset (e.g. cluster), all edges with a length greater than (Dmin/2) are removed or deleted. This ensures that points from other wires are not mistakenly grouped together, thereby possibly forming an inaccurately thick wire. The removal of some long edges may lead to the creation of multiple smaller subsets. These smaller subsets are still part of a common cluster, as identified earlier based on their projections onto a common plane. At block 290, the subset with largest number of points is identified and, at block 292, a line is computed through the subset using least squares. The RMS distance is determined between the points in the subset and the computed line (block 294). At block 296, it is determined whether the RMS distance is greater than the threshold trms. If not, the line is not classified as part of an ancillary wire (block 298) and the subset with the next largest group of points is identified (block 300). The operations in blocks 292, 294, 296, 298, and 300 are repeated until a subset is identified or classified to be part of an ancillary line. If the subset and the line are classified as a segment of an ancillary wire (block 302). At block 304, the computing device 20 continues to search for other subsets, which are within the cluster, having the property where the RMS distance is less than or equal to the threshold trms. At block 306, once several line segments of the ancillary wire are identified, then they are connected to construct a complete ancillary wire.

As discussed above, the above process (e.g. block 288 to block 306) applies to each cluster. In other words, if there are three identified clusters, the above process is applied three times to possibly construct three separate ancillary wires.

In another aspect, module 38 may include computer executable instructions for extracting wires (e.g. power lines, cables, pipes, rope, etc.) from a noisy environment. Noise, e.g. noisy data, in a point cloud may be created from vegetation, precipitation, birds, etc., which may surround a wire. The noise may make it difficult to extract wire features from a point cloud.

In general, a method is provided for extracting wires from a noisy environment by projecting points to a plane perpendicular to a known wire segment and analysing the density of the projections. A noisy environment includes “noisy” points that do not represent a wire. The noisy points increase the difficulty of accurately extracting wires from the set of data points, especially if they are located close to points representing a wire. In particular, a proposed extension of the known wire is generated to establish a “neighbourhood”. The projections of the majority of points which belong to the wire will be concentrated within the neighbourhood, whereas noisy points will be distributed outside the neighbourhood. If the density of points in the neighbourhood is sufficiently high, then the proposed extension of the known wire is accepted. These operations are repeated, whereby each iteration may add a new extension or segment to the wire.

Turning to FIG. 27, example computer executable instructions are provided for extracting wires from a noisy environment. The initial conditions assume that a line L_{R}, which represents a known wire segment, is known, and that the point cloud P includes a number of unclassified points. The known wire segment may be computed, for example, using the operations described with respect to FIGS. 21, 22 and 23. It may also be assumed that the ground surface has been identified.

At block 311, an end of the known wire segment L_{R} is assigned to be the origin (O) of a coordinate frame. At block 313, the vector of the line L_{R} is assigned to be the vector of the Y-axis. At block 315, the direction of the X-axis is computed so that the plane defined by XOY is parallel to the ground surface, or to the horizontal plane. It can be appreciated that the ground surface within the local vicinity of the origin O may likely be horizontal. At block 317, the Z-axis of the coordinate frame is computed to be perpendicular to the XOY plane.

At block 319, a first polygon (e.g. rectangle, ellipse, circle, square, etc.) and a second polygon (e.g. rectangle, ellipse, circle, square, etc.) are constructed to meet several criteria. The first and second polygons are constructed so that they both lie on the XOZ plane, and contain the origin as its center. It can be appreciated that the line L_{R} is normal to the XOZ plane. In another criterion, the second polygon must be larger than the first polygon. In some examples, circle-shaped polygons are used to search a further distance away from the line L_{R}. In other examples, rectangular and square-shaped polygons are used to increase computational efficiency.

After the first and the second polygons are constructed meeting the above-described criteria, at block 321, a proposed line of a certain length (S) is extended from the origin O along the Y-axis, although not necessarily in the same direction as the Y-axis. In this way, the proposed line is collinear with the line L_{R}. The proposed line of length S is a proposed extension of the known wire segment. The length S may or may not change with each iteration. The length S may be determined using statistical distribution of the points around the line L_{R}. For example, if the RMS value of points around the line L_{R} is high, then the length S may be selected to be longer in order to accommodate for the greater data variability.

At block 323, each of the points, e.g. the unclassified points, may be classified as belonging to the “first neighbourhood” of the first polygon if: the point projects perpendicularly to Y onto the extended line of length S; and, the point projects parallel to Y onto the plane XOZ within the perimeter of the first polygon. The number of points that are classified as belonging to the “first neighbourhood” is represented by n1. Similarly, at block 325, each of the points, e.g. the unclassified points, may be classified as belonging to the “second neighbourhood” of the second polygon if: the point projects perpendicularly to Y onto the extended line of length S; and, the point projects parallel to Y onto the plane XOZ within the perimeter of the second polygon. The number of points that are classified as belonging to the “second neighbourhood” is represented by n2. It can be appreciated that since the second polygon is larger than the first polygon and encompasses the first polygon, then all the “first neighbourhood” points are also classified as the “second neighbourhood” points (e.g. n2≧n1). As indicated by circle E, the method of FIG. 27 continues to FIG. 28.

Continuing to FIG. 28, at block 327, the computing device 20 then determines if the following conditions are true: n1 is less than a threshold (N), e.g. n1<N; or, the maximum distance (Tmax) between a “first neighbourhood” point and the origin O is less than another threshold (Tval), e.g. Tmax<Tval. These thresholds are in place in order to prevent noise in the data from extending the wire along line S. For example, if N=3 then at least three data points must be found to extend the wire along line S. In another example, if Tval=S/10, then the farthest “first neighbourhood” data point must be sufficiently located sufficiently far from the origin O to extend the wire along line S. In another example embodiment, the second condition (e.g. Tmax<Tval) may be controlled by also determining how a “first neighbourhood” point is classified. In other words, by determining the dimension of the first polygon and the length S, the furthest possible distance between a “first neighbourhood” point and the origin O may be calculated. It can be appreciated that if the first condition (e.g. n1<N) is true, then the wire cannot be extended along the proposed line extension of length S, since there is an insufficient number of data points. If the second condition (e.g. Tmax<Tval) is true, then the wire cannot be extended along the proposed line extension of length S, since it is perceived that the “first neighbourhood” points do not provide sufficient information. In other words, if either condition is true, then the set of data is not validated.

Continuing to block 328, it is determined whether at least one of the conditions set out in block 327 is true. If so, at block 330, it is determined the set of “first neighbourhood” points do not provide sufficient information for, possibly, constructing an extension of the wire or line L_{R}. In order to increase the possibility of obtaining a set of valid “first neighbourhood” points, the length S of the proposed line extension is increased. The method then returns to block 321, using the increased length S, and thereafter repeats the operations set forth in the subsequent blocks (e.g. blocks 323, 325, etc.). If neither of the conditions are true, e.g. the “first neighbourhood” points provide sufficient data, then at block 332, the point densities associated with the first polygon and the second polygon are calculated. In particular, the point density D1 associated with the “first neighbourhood” is computed according to D1=n1/(area of the first polygon). Similarly, the point density D2 associated with the “second neighbourhood”, not including the “first neighbourhood”, is computed according to D2=(n2−n1)/(area of the second polygon−area of the first polygon). At block 334, it is determined if the ratio of the point densities between the different neighbourhoods exceeds a selected threshold (D0). For example, if D0=1, e.g. ratio greater than 1, then this would require that there are likely more points that represent a wire, rather than noisy points. A D0 value of less than 1 would be tolerant of noise around the wire and would cause the process to “plunge” through the noise. A D0 value of greater than 1 would be very sensitive to noise around the wire and, thus, would cause the process to stop in the presence of too much noise. In other words, it is determined if the relationship (D1/D2)>D0 is true. If so, then the proposed wire extension is extended along the length S (block 334), and the process returns to block 310 to implement another iteration for extending the length of the wire (block 338). If the relationship (D1/D2)>D0 is not true, then at block 340, the proposed wire extension is not allowed to extend along the length S. If the wire is not extended, it may be interpreted that an obstacle was found along the wire path and the wire cannot be extended through it.

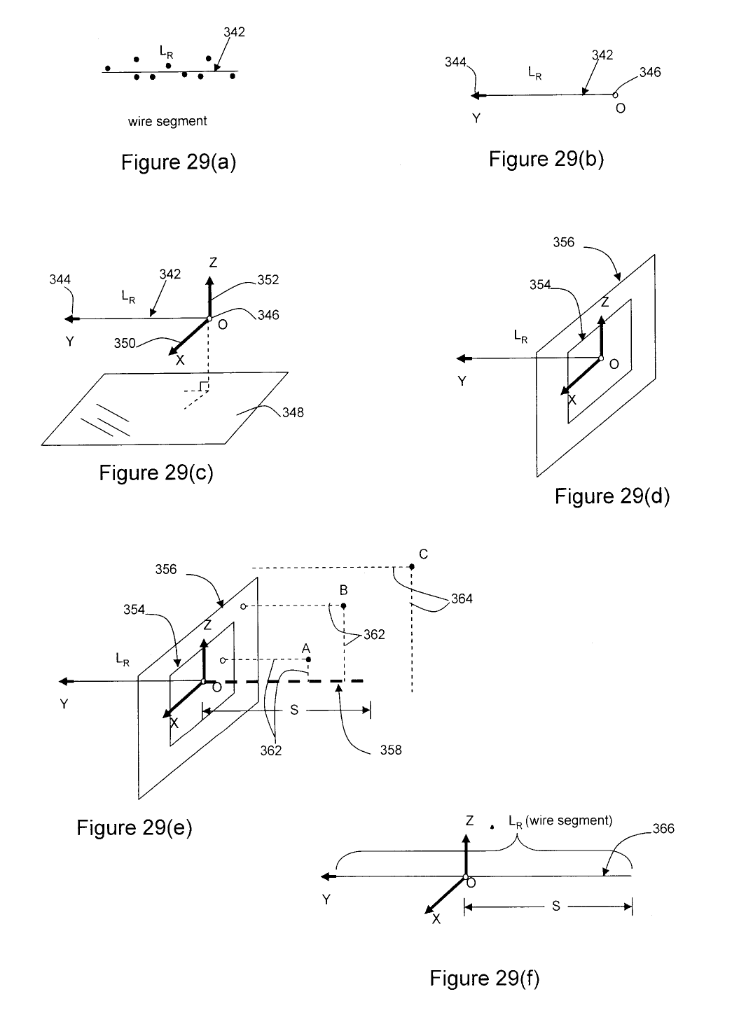

Turning to FIGS. 29(a) through 29(f), a series of illustrations are provided to show example stages for extracting a wire in a noisy environment. These illustrations generally correspond to the operations described with respect to FIGS. 27 and 28. In FIG. 29(a), a known wire segment 342 has been obtained from data points, and is represented by the line L_{R} 342. FIG. 29(b) shows the addition of the origin O 346 added to one end of the line L_{R} 342, as well as the addition of the Y-axis 344 that is collinear to the line L_{R} 342. FIG. 29(c) shows a configuration of the X-axis 350, so that the plane defined by XOY is parallel to the horizontal or ground surface plane 346. The Z-axis 352 is constructed to be normal to the XOY plane. Turning to FIG. 29(d), a first polygon 354 and a second polygon 356 are constructed in the ZOX plane. In this case, the polygons 354 and 356 are both rectangles. The first rectangle 354 has the dimensions H1, W1 and the second rectangle 356 has the dimensions H2, W2. In FIG. 29(e), a proposed wire or line extension 358 of length S is shown extending from the origin O 346. Other points A, B, C, among others, are being considered. Point A has projections onto the ZOX plane, within the area defined by the first rectangle 354, and onto the proposed line extension 358. Therefore, point A is classified as a “first neighbourhood” point. The projections for point A are illustrated with dotted lines 360. Point B has projections onto the ZOX plane, within the area defined by the second rectangle 356, and onto the proposed line extension 358. Therefore, point B is classified as a “second neighbourhood” point. The projections for point B are illustrated with dotted lines 362. Point C, as shown by dotted lines 364, does not project on to the line 358 or onto the area defined by either the first rectangle 354 or second rectangle 356. Thus, point C is neither classified as a first or second neighbourhood point. If the first neighbourhood points provide sufficient information, and the point density within the neighbourhoods is sufficiently high (e.g. see blocks 327 and 332), then a proposed line extension 358 is added to the existing or known wire line L_{R} 342. In the example of rectangles, the density values D1 and D2 may calculated using: D1=n1/(W1*H1) and D2=(n2−n1)/(W2*H2−W1*H1). The new or extended line 366 is shown in FIG. 29(f).

It can be appreciated the method described with respect to FIGS. 27 and 28 may be used in combination with the method for extracting wires, as described with respect to FIGS. 21, 22 and 23. In this way, wires can be extracted from noisy environments.

In another aspect, module 44 may include computer executable instructions for extracting the terrain and relief features of the ground from a point cloud P. In particular, it may be determined whether the ground surface is hilly, “grade” (e.g. slightly hilly), or flat, and whether the ground has vegetation or is soft (e.g. has no vegetation).

In general, the method is based on the analysis and estimation of the slopes and statistical dispersion of small local areas, e.g. sub-tiles and tiles, within the point cloud P. Since the relief and terrain are usually characteristics that are local to the earth surface, they can only be accurately calculated for small local areas. The method for extracting terrain and relief features may be based on several assumptions. A first assumption is that for local (e.g. small-size) areas with a lot of vegetation, the dispersion of data points is usually greater than for similar-sized areas without vegetation. A second assumption is that hilly areas have much bigger inclination angles towards the horizontal plane compared to flat areas. The second assumption supposes that only ground-reflected points are used for the slopes estimation (e.g. even for dense vegetation areas). It can be appreciated that the method uses a statistical approach and, thus, random errors may not likely influence the accuracy of the method's result.

Turning to FIG. 30, example computer executable instructions are provided for extracting relief and terrain features from a point cloud P. At block 370, the point cloud is separated or divided into horizontal tiles (e.g. squares) of dimension T. At block 372, each of the tiles are further separated into sub-tiles (e.g. smaller squares) of dimension A, where A<T. An example of value for T would be the width of a standard mapping tile according to many state or federal organizations standards used to subdivide digital mapping data. In particular, the tile size T would vary depending on the scale of the mapping. In many instances, when digital data is produced, it has already been subdivided into these rectangular units. The dimension A of a sub-tile is preferably chosen large enough to have a high probability of having at least one true ground surface point in each sub-tile, while balancing the desire to have small enough sub-tiles in each tile so that a large enough number of sub-tiles can accurately represent the ground surface of a tile. In one example embodiment, the sub-tile dimension A is in the range between 5 and 10 meters.

After the sub-tiles are created, a number of operations (e.g. blocks 374 and 376) are applied to each sub-tile in a tile. In particular, at block 374, any data caused by instrument error and/or by anomalies is removed or filtered out. In other words, large errors, such as gross errors caused by equipment collection malfunction, and recognised by being a multiple number of standard deviations from the mean should be removed. Natural anomalies, such as a point coincidentally measured at the bottom of a well or crevasse, could also cause such deviations and are normally removed. At block 376, the point with the lowest or elevation is identified within each sub-tile. It is likely that the lowest points are the ground points.

Continuing with FIG. 30, at block 378, for each tile in the point cloud, the lowest points from each sub-tile are connected to form a triangulated surface. This may be performed by applying Delaunay's triangulation algorithm. In this way, a ground surface (e.g. the triangulated surface) is constructed for each tile.

Block 380 includes a number of operations for classifying the relief of the ground surface in a tile. The operations in block 380 include using the triangles formed by the triangulation network cover (block 382). These triangles may also be referred herein as ground surface triangles. The inclination angle between each ground surface triangle and the horizontal plane is measured. The inclination angle may also be determined by measuring the angle between the normal of a ground surface triangle and the vertical axis. After determining the inclination angles for each triangle in the tile, at block 384, the number of triangles with inclination angles greater than some angle (Incl. 1) is determined. Similarly, the number of triangles with inclination angles between Incl. 2 and Incl. 1 is determined, and the number of triangles with inclination angles less than Incl. 2 is determined. It can be appreciated that Incl. 2<Incl. 1. In an exemplary embodiment, Incl. 1=10° and Incl. 2=5°. As indicated by circle F, the method of FIG. 30 continues to FIG. 31.

Continuing to FIG. 31, at block 386, if the number of triangles, having inclination angles more than Incl. 1, is greater than some percentage μ1 of the total number of triangles in the tile, then the tile is classified as “hilly”. If the number of triangles, having inclination angles between Incl. 2 and Incl. 1, is greater than some percentage μ2 of the total number of triangles in the tile, then the tile is classified as “grade”. If none of those conditions are true, then the tile is classified as “flat”. In an exemplary embodiment, the value of the parameters are: Incl. 1=10°; Incl. 2=5°; μ1=20%; and μ2=20%.

Continuing with FIG. 31, another set of operations (block 388) are used to classify whether a tile has vegetation or not. A number of operations (blocks 390, 392, 394) are applied to each sub-tile in a tile. In particular, at block 390, it is determined if a sub-tile has at least a certain number of points (n-sub), e.g. n-sub=10 points. If not, at block 392, the sub-tile is not considered in the calculation since it is considered to have insufficient data. If the sub-tile does have enough data points, then at block 394, the standard deviation of the points' heights from the ground surface is determined for the sub-tile.

After collecting the standard deviations of heights associated with many, if not all, sub-tiles within the tile, the number of sub-tiles having a standard deviation of more than a certain height (Hdev) is determined (block 398). This accounting of sub-tiles is determined for each tile. An example standard deviation height Hdev is 1 meter. It can be understood that a higher number of sub-tiles with a large standard deviation may indicate that there is more variation of height in the data points. A higher variation of height may indicate the presence of vegetation.

In particular, at block 398, it is determined if the number of sub-tiles, having a standard deviation of more than Hdev, exceed a certain percentage ω (e.g. ω=15%) of the total number of sub-tiles that were considered within the tile. It can be appreciated that varying the values of the standard-deviation threshold Hdev and the certain percentage may change the sensitivity for the terrain classification. These values, for example, may be empirically tuned. If the condition at block 398 is true, then at block 402 the tile's terrain is classified at “vegetation”. If not, then at block 400 the terrain is classified as “soft” (e.g. no vegetation).

It can thus be seen that the relief and the terrain classification may be used characterize a tile as one of: hilly and vegetation; hilly and soft; grade and vegetation; grade and soft; flat and vegetation; or, flat and soft (block 404). In one embodiment, the relief and terrain extraction module 44 can be used to automatically determine the relief and vegetation classification of a tile (or data set) so that different sets of criteria can be automatically applied in the ground surface extraction module 32.

The above principles for extracting various features from a data point cloud P may be applied to a number of industries including, for example, mapping, surveying, architecture, environmental conservation, power-line maintenance, civil engineering, real-estate, building maintenance, forestry, city planning, etc. The different software modules may be used alone or together to more quickly and automatically extract features from point clouds having large data sets, e.g. hundreds of millions or even billions of points.

In view of the above, it is appreciated the principles described herein generally include the following.

A method is provided for a computing device to extract a ground surface from a set of data points with three-dimensional spatial coordinates. The method comprises: the computing device establishing a grid of tiles over the set of data points, each of the tiles of a predetermined dimension; the computing device identifying a data point with the lowest height in each of the tiles; the computing device forming a triangulated surface using the lowest height data points, wherein the triangulated surface is the ground surface.

The method also includes the tile dimension having a form T×T, where the length T is greater than a length of a base of a building, the building also represented by a subset of the set of data points. In another aspect, a Delaunay triangulation algorithm is used to form the triangulated surface. In another aspect, the computing device identifies additional data points as ground surface points, and in this regard the method further comprises: identifying data points that are within a horizontal distance R from any one of the lowest height data points, the identified data points grouped as a set of R-points; removing from the set of R-points any data points that are located above the triangulated surface by a predetermined height MaxH and any data points that are located below a predetermined height MinH; and wherein at least one of the remaining R-points in the set of R-points are classified as part of the ground surface. In another aspect, for the at least one of the remaining R-points in the set of R-points, the computing device determining if a triangle in the triangulated surface, that is below the remaining R-point, is longer than the tile dimension T and if so: the computing device determining an angle A2 subtended between a line and the horizontal plane, the line connecting the remaining R-point to a ground point closest to the remaining R-point; and if the angle A2 is less than an elevation angle Maxα, then the computing device classifying the remaining R-point as part of the ground surface. In another aspect, for the at least one of the remaining R-points in the set of R-points, the computing device determining if a triangle in the triangulated surface, that is below the remaining R-point, is longer than the tile dimension T and if not: determining an angle A1 subtended between a line and the triangulated surface, the line connecting the remaining R-point to a ground point closest to the remaining R-point; determining an angle A2 subtended between the line and the horizontal plane; and if the smaller of the angle A1 and the angle A2 is less than an elevation angle Maxα, then the computing device classifying the remaining R-point as part of the ground surface. In another aspect the computing device re-forms a triangulated surface by combining the data points in the triangulated surface and the at least one of the remaining R-points classified as part of the ground surface, wherein the re-formed triangulated surface is the ground surface. In another aspect, the computing device computes an average height of the data points of the ground surface to filter out irregularities. In another aspect, Maxα is less than 2°.

A method is also provided for a computing device to extract a building model from a set of data points with three-dimensional spatial coordinates. The method comprises: the computing device obtaining a set of ground surface points from the set of data points, the ground surface points classified as base points; the computing device applying a triangulation algorithm to the data points that are not the base points to construct a triangulated surface; the computing device removing edges from the triangulated surface that have at least one point classified as a base point; the computing device re-applying the triangulation algorithm to the triangulated surface to generate one or more subsets of triangulated and interconnected paints; the computing device identifying a large subset defined by a plan-view area of the large subset being above a predetermined threshold; and the computing device classifying the large subset as the building model.

The method further includes using a Delaunay triangulation algorithm. In another aspect, the computing device classifies non-ground surface points located within a threshold height above a ground surface as part of the base points, wherein the ground surface is defined by the ground surface points. In another aspect, the threshold height is half of a storey. In another aspect, the method further comprises: upon removing the edges from the triangulated surface, the computing device further removing subsets of triangulated and interconnected points, if the subsets meet at least one of the following criteria: the subset has a plan-view area smaller than another pre-determined threshold; and the subset has a length-to-width ratio that exceeds a ratio threshold. In another aspect, upon identifying the large subset, the computing device determining if another large subset is within a threshold distance from the large subset and, if so, classifying both large subsets as part of the building model. In another aspect, upon removing edges from the triangulated surface, the computing device further removing any texture points from the triangulated surface. In another aspect, the computing device applying an edge detection algorithm to the data point representing the building and applying a surface reconstruction algorithm to the building to construct a 3D visualization of the building model.

A method is also provided for a computing device to remove data points representing vegetation from a set of data points, the set of data points with three-dimensional spatial coordinates of at least the vegetation and a ground surface. The method comprises the computing device obtaining a set of ground surface points and non-ground surface points from the set of data points; the computing device applying a triangulation algorithm to the non-ground surface points to construct a triangulated surface; the computing device removing edges from the triangulated surface that are longer than a predetermined length and are at an angle greater then 45° above the horizontal plane; and the computing device removing small subsets having a plan-view area smaller than a predetermined threshold.

In another aspect of the method, the triangulation algorithm is a Delaunay triangulation algorithm.

A method is also provided for a computing device to construct a polygonal building model from a set of data points with three-dimensional spatial coordinates of a building. The method comprises: the computing device computing a histogram of the number of data points along a vertical axis; the computing device classifying a height of each local maximum of the histogram as a height of a separate building layer; the computing device applying a triangulation algorithm to the data points lying within each of the separate building layers to construct a triangulated layer correspond to each separate building layer; the computing device removing long edges, that are longer than a threshold, from each of the triangulated layers; the computing device forming a boundary line for each triangulated layer, the boundary line formed from the outer edges of each triangulated layer; and for each triangulation layer, the computing device projecting the boundary line downwards to a triangulated layer below to generate walls of the polygonal building model.

In another aspect of the method, the triangulation algorithm is a Delaunay triangulation algorithm. In another aspect, the local maximum is identified as a value exceeding the closest local minimum by a given percent. In another aspect, the computing device removing long edges from each of the triangulated layers, the long edges each being longer than a threshold length. In another aspect, upon forming the boundary line, the computing device determining if the number of points in the boundary line exceed a threshold number, and if so, applying a line filtering algorithm of the boundary line. In another aspect, the line filtering algorithm is a Douglas-Peuker line filter. In another aspect, for a lowest triangulated layer, the computing device projecting its boundary line downwards to reach a ground surface of the building model. In another aspect, the computing device constructs horizontal surfaces at each triangulated layer to form a roof or a ledge of the building model. In another aspect, the computing device classifying the tallest triangulated layer as a roof of the polygonal building model; and identifying points, located above the roof within a predefined height, as representative of a roof structure. In another aspect, the computing device constructs a roof structure model, in which the method further comprises: applying the triangulation algorithm to points representative of the roof structure at predetermined step heights to construct one or more roof structure layers; computing a boundary line for each of the one or more roof structure layers; and projecting the boundary line of each of the one or more roof structures downwards to the roof structure layer below to form surfaces of the roof structure model. In another aspect, the roof structure is any one of a tower, chimney, antenna, and air unit.

A method is also provided for a computing device to extract a wire from a set of data points with three-dimensional spatial coordinates. The method comprises: the computing device obtaining ground surface points, representative of the ground surface, and non-ground surface points from the set of data points; the computing device applying a triangulation algorithm to the non-ground surface points to construct a triangulated surface; the computing device removing points from the triangulated surface that are lower than a predetermined height from the ground surface; the computing device removing points from the triangulated surface that are sparsely located; the computing device removing edges from the triangulated surface that have a length greater than a predetermined length Dmin; the computing device identifying a largest subset of interconnected data points in the triangulated surface; the computing device computing a line through the largest subset; and wherein the line is the wire.

In another aspect of the method, the line is computed by performing a least squares calculation of the points in the largest subset. In another aspect, the method further comprises: the computing device computing the root mean square (RMS) distance between the points in the largest subset and the computed line; if the RMS distance is greater than a threshold trms, then the computing device classifying the line as not part of the wire. In another aspect, the method further comprises: the computing device searching for another subset proximate to at least one of the ends of the line; the computing device computing another line through the other subset; and if the other line and the line are approximately collinear, the computing device connecting the other line and the line to form the wire. In another aspect, the computing device extracts another wire located proximal to the wire, and in this regard the method further comprises: computing a plane perpendicular to a segment of the wire; projecting points of the triangulated surface onto the plane; identifying a cluster of the point projections on the plane; applying the triangulation algorithm to the data points corresponding the clustered point projections to form a subset; removing edges within the subset that are longer than (Dmin/2); and computing a line through the subset to form the other wire. In another aspect, the cluster of the point projections is computed using any one of the following clustering algorithms: nearest-neighbour, k-means and fuzzy clustering. In another aspect, the wire is anyone of a power line, cable, pipe and rope. In another aspect, the triangulation algorithm is a Delaunay triangulation algorithm. In another aspect, if less than 25 points are located within a square meter, these sparsely located points are removed. In another aspect, the predetermined height above the ground is 2 meters.

A method is also provided for a computing device to extract a wire from a set of data points with three-dimensional spatial coordinates. The method comprises: the computing device constructing an XYZ frame of reference comprising an origin O at an end of a known wire segment represented by line L_{R}, a Y axis collinear with the line L_{R}, and a plane XOY that is parallel to a ground surface; computing a first polygon and a second polygon both coplanar with a plane XOZ and both having the origin O at their centre, the second polygon larger than the first polygon; computing a line S of finite length extending from the origin O and collinear with the line L_{R}; computing a number of data points n1 that project on to the line S and project on to the plane XOZ within a perimeter of the first polygon; computing a number of data points n2 that project on to the line S and project on to plane XOZ within a perimeter of the second polygon; determining if the line S represents a segment of the wire by using the number of points n1 and n2; and, if so, forming the wire by combing the lines S and L_{R}.

In another aspect of the method, the first polygon and the second polygon are any one of a rectangle, ellipse, circle and square. In another aspect, the length of the line S is proportionally related to the root mean square distance of data points surrounding the line L_{R}. In another aspect, determining if the line S represents the segment of the wire comprises: the computing device determining if a ratio of point densities D1 and D2 is greater than a threshold D0, then classifying the line S as the segment of the wire; and wherein D1=n1/(area of the first polygon) and D2=(n2−n1)/(area of the second polygon−the area of the first polygon). In another aspect, the threshold D0 is 1. In another aspect, upon computing n1, the computing device determines if at least one of the following conditions is true: n1 is less than a threshold N; and a largest distance Tmax between any one of the n1 data points and the origin O is less than a threshold Tval; and if so, increasing the length of the line S.

A method is also provided for a computing device to classify points forming a relief of a ground surface from a set of data points with three-dimensional spatial coordinates. The method comprises: the computing device separating the set of data points into horizontal tiles; the computing device forming a triangulated surface comprised of the lowest point from each of the horizontal tiles, the triangulated surface identified as the ground surface; and the computing device classifying the relief of the ground surface based on computed inclination angles of each triangle within the ground surface relative to a horizontal plane.

In another aspect, the inclination angle is computed by determining an angle between a normal vector of a triangle and a vertical axis. In another aspect, classifying the relief of the ground surface further comprises: determining a number of triangles within each of the following categories. The categories include: a first category wherein a given inclination angle is greater than an angle Incl. 1; a second category wherein a given inclination angle is less than Incl. 1 and greater than an angle Incl. 2, wherein Incl. 2<Incl. 1; and a third category wherein a given inclination angle is less than Incl. 2. Upon determining the number of triangles in each category, classifying the relief of the ground surface based on a computed percentage of the number of triangles in at least one of the categories. In another aspect, Incl. 1 is 10° and Incl. 2 is 5°. In another aspect, the relief of the ground surface is classified as any one of “hilly”, “grade” and “flat”. In another aspect, if the percentage of triangles in the first category is greater than 20%, classifying the relief as “hilly”. In another aspect, if the percentage of triangles in the second category is more than 20%, classifying the relief as “grade”. In another aspect, if the percentage of triangles in the first category and the percentage of triangles in the second category are both less than 20%, classifying the relief as “flat”. In another aspect, a Delaunay triangulation algorithm is used to compute the triangulated surface.

A method is also provided for a computing device to classify a ground surface with vegetation from a set of data points with three-dimensional spatial coordinates. The method comprises: the computing device separating the set of data points into horizontal tiles; the computing device forming a triangulated surface comprised of the lowest point from each of the horizontal tiles, the triangulated surface identified as the ground surface; computing for each tile a standard deviation of the data points' heights relative to the ground surface; and the computing device classifying the ground surface with vegetation based on a percentage of tiles having the standard deviation above a predetermined height Hdev.

In another aspect of the method, a Delaunay triangulation algorithm is used to compute the triangulated surface. In another aspect, Hdev is 1 meter. In another aspect, classifying the ground surface with vegetation further comprises: the computing device determining if the percentage of tiles exceeds a predetermined percent ω; and, if so, the computing device classifying the ground surface as “vegetation”. In another aspect, ω is 15%. In another aspect, upon forming the ground surface, the computing device removing tiles having less than a predetermined number of points n-sub. In another aspect, n-sub is 10 points.

A method is also provided for extracting features from a data set representing spatial coordinates. The method comprises: extracting an approximate ground surface from the data; characterising the relief and terrain of the approximate ground surface; extracting an accurate ground surface based on the characterised relief and terrain; extracting building points from data located above the accurate ground surface; and, reconstructing a building model from the building points.

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method for a computing device to extract a ground surface from a set of data points with three-dimensional spatial coordinates, the method comprising:
the computing device establishing a grid of tiles over the set of data points, each of the tiles of a predetermined dimension;
the computing device identifying a data point with the lowest height in each of the tiles;
the computing device forming a triangulated surface using the lowest height data points, wherein the triangulated surface is the ground surface.

2. The method of claim 1 wherein the tile dimension is of a form T×T, where the length T is greater than a length of a base of a building, the building also represented by a subset of the set of data points.

3. The method of claim 1 wherein a Delaunay triangulation algorithm is used to form the triangulated surface.

4. The method of claim 1 further comprising the computing device identifying additional data points as ground surface points, the method further comprising:
identifying data points that are within a horizontal distance R from any one of the lowest height data points, the identified data points grouped as a set of R-points;
removing from the set of R-points any data points that are located above the triangulated surface by a predetermined height MaxH and any data points that are located below a predetermined height MinH; and
wherein at least one of the remaining R-points in the set of R-points are classified as part of the ground surface.

5. The method of claim 4 further comprising, for the at least one of the remaining R-points in the set of R-points:
the computing device determining if a triangle in the triangulated surface, that is below the remaining R-point, is longer than the tile dimension T and if so:
the computing device determining an angle A2 subtended between a line and the horizontal plane, the line connecting the remaining R-point to a ground point closest to the remaining R-point; and
if the angle A2 is less than an elevation angle Maxα, then the computing device classifying the remaining R-point as part of the ground surface.

6. The method of claim 4 further comprising, for the at least one of the remaining R-points in the set of R-points:
the computing device determining if a triangle in the triangulated surface, that is below the remaining R-point, is longer than the tile dimension T and if not:
determining an angle A1 subtended between a line and the triangulated surface, the line connecting the remaining R-point to a ground point closest to the remaining R-point;
determining an angle A2 subtended between the line and the horizontal plane; and
if the smaller of the angle A1 and the angle A2 is less than an elevation angle Maxα, then the computing device classifying the remaining R-point as part of the ground surface.

7. The method of claim 4 further comprising the computing device re-forming a triangulated surface by combining the data points in the triangulated surface and the at least one of the remaining R-points classified as part of the ground surface, wherein the re-formed triangulated surface is the ground surface.

8. The method of claim 1 further comprising the computing device computing an average height of the data points of the ground surface to filter out irregularities.

9. The method of claim 5 wherein Maxα is less than 2°.

10. (canceled)

11. A method for a computing device to extract a building model from a set of data points with three-dimensional spatial coordinates, the method comprising:
the computing device obtaining a set of ground surface points from the set of data points, the ground surface points classified as base points;
the computing device applying a triangulation algorithm to the data points that are not the base points to construct a triangulated surface;
the computing device removing edges from the triangulated surface that have at least one point classified as a base point;
the computing device re-applying the triangulation algorithm to the triangulated surface to generate one or more subsets of triangulated and interconnected paints;
the computing device identifying a large subset defined by a plan-view area of the large subset being above a predetermined threshold; and
the computing device classifying the large subset as the building model.

12.-19. (canceled)

20. A method for a computing device to remove data points representing vegetation from a set of data points, the set of data points with three-dimensional spatial coordinates of at least the vegetation and a ground surface, the method comprising:
the computing device obtaining a set of ground surface points and non-ground surface points from the set of data points;
the computing device applying a triangulation algorithm to the non-ground surface points to construct a triangulated surface;
the computing device removing edges from the triangulated surface that are longer than a predetermined length and are at an angle greater then 45° above the horizontal plane; and
the computing device removing small subsets having a plan-view area smaller than a predetermined threshold.

21.-22. (canceled)

23. A method for a computing device to construct a polygonal building model from a set of data points with three-dimensional spatial coordinates of a building, the method comprising:
the computing device computing a histogram of the number of data points along a vertical axis;
the computing device classifying a height of each local maximum of the histogram as a height of a separate building layer;
the computing device applying a triangulation algorithm to the data points lying within each of the separate building layers to construct a triangulated layer correspond to each separate building layer;
the computing device removing long edges, that are longer than a threshold, from each of the triangulated layers;
the computing device forming a boundary line for each triangulated layer, the boundary line formed from the outer edges of each triangulated layer; and
for each triangulation layer, the computing device projecting the boundary line downwards to a triangulated layer below to generate walls of the polygonal building model.

24.-34. (canceled)

35. A method for a computing device to extract a wire from a set of data points with three-dimensional spatial coordinates, the method comprising:
the computing device obtaining ground surface points, representative of the ground surface, and non-ground surface points from the set of data points;
the computing device applying a triangulation algorithm to the non-ground surface points to construct a triangulated surface;
the computing device removing points from the triangulated surface that are lower than a predetermined height from the ground surface;
the computing device removing points from the triangulated surface that are sparsely located;
the computing device removing edges from the triangulated surface that have a length greater than a predetermined length Dmin;
the computing device identifying a largest subset of interconnected data points in the triangulated surface;
the computing device computing a line through the largest subset; and
wherein the line is the wire.

36.-45. (canceled)

46. A method for a computing device to extract a wire from a set of data points with three-dimensional spatial coordinates, the method comprising:
the computing device constructing an XYZ frame of reference comprising an origin O at an end of a known wire segment represented by line L_{R}, a Y axis collinear with the line L_{R}, and a plane XOY that is parallel to a ground surface;
computing a first polygon and a second polygon both coplanar with a plane XOZ and both having the origin O at their centre, the second polygon larger than the first polygon;
computing a line S of finite length extending from the origin O and collinear with the line L_{R};
computing a number of data points n1 that project on to the line S and project on to the plane XOZ within a perimeter of the first polygon;
computing a number of data points n2 that project on to the line S and project on to plane XOZ within a perimeter of the second polygon;
determining if the line S represents a segment of the wire by using the number of points n1 and n2; and
if so, forming the wire by combing the lines S and L_{R}

47.-52. (canceled)

53. A method for a computing device to classify a relief of a ground surface from a set of data points with three-dimensional spatial coordinates, the method comprising:
the computing device separating the set of data points into horizontal tiles;
the computing device forming a triangulated surface comprised of the lowest point from each of the horizontal tiles, the triangulated surface identified as the ground surface; and
the computing device classifying the relief of the ground surface based on computed inclination angles of each triangle within the ground surface relative to a horizontal plane.

54.-62. (canceled)

63. A method for a computing device to classify a ground surface by vegetation from a set of data points with three-dimensional spatial coordinates, the method comprising:
the computing device separating the set of data points into horizontal tiles;
the computing device forming a triangulated surface comprised of the lowest point from each of the horizontal tiles, the triangulated surface identified as the ground surface;
computing for each tile a standard deviation of the data points' heights relative to the ground surface; and
the computing device classifying the ground surface by vegetation based on a percentage of tiles having the standard deviation above a predetermined height Hdev.

64.-70. (canceled)

71. A method for extracting features from a data set representing spatial coordinates, the method comprising:
extracting an approximate ground surface from the data;
characterising the relief and terrain of the approximate ground surface;
extracting an accurate ground surface based on the characterised relief and terrain;
extracting building points from data located above the accurate ground surface; and,
reconstructing a building model from the building points.
